(19) United States
(12) Patent Application Publication
(10) Pub. No.: US 2025/0111249 A1
(43) Pub. Date: Apr. 3, 2025

(54) SYSTEMS AND METHODS FOR DISTRIBUTED SEMANTIC MANAGEMENT, MEASUREMENT AND CONTROL

(71) Applicant: Apple Inc., Cupertino, CA (US)

(72) Inventors: Saeideh Parsaei Fard, Cupertino, CA (US); Sabine Roessel, Munich (DE); Matthias Sauer, San Jose, CA (US); Bernhard Raaf, Neuried (DE)

(21) Appl. No.: 18/893,463

(22) Filed: Sep. 23, 2024

Related U.S. Application Data
(60) Provisional application No. 63/541,650, filed on Sep. 29, 2023.
(60) Provisional application No. 63/541,697, filed on Sep. 29, 2023.
(60) Provisional application No. 63/541,915, filed on Oct. 2, 2023.

(51) Int. Cl. G06N 5/022

(52) U.S. Cl. CPC G06N 5/022

(57) ABSTRACT

Disclosed are methods, systems, and computer-readable medium to perform operations including: obtaining, by a first computer system, source data for transmission to a second computer system; generating, by the first computer system, first semantically encoded data representing the source data, wherein the first semantically encoded data is generated based on (i) a first computer knowledge base stored locally by the first computer system, and (ii) a second computer knowledge base shared between the first computer system and the second computer system; decoding, by the first computer system, the first semantically encoded data based on the second computer knowledge base to generate semantically decoded data; comparing, by the first computer system, the source data and the semantically decoded data; and selectively transmitting, by the first computer system, a pilot signal to the second computer system based on the comparison between the source data and the semantically decoded data.

### BACKGROUND

Wireless communication networks provide integrated communication platforms and telecommunication services to wireless user devices. Example telecommunication services include telephony, data (e.g., voice, audio, and/or video data), messaging, and/or other services.

The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Traditional wireless communications focus on improving the accuracy of symbol transmissions. For example, a transmitter (TX) device, such as a TX user equipment (UE), encodes information into a stream of symbols according to a predefined protocol and transmits the encoded symbols via one or more wireless channels. Correspondingly, a receiver (RX) device, such as an RX UE, receives the stream of symbols and decodes the symbols to recover the transmitted information. Because the transmission is typically susceptive to noise and interference, the information symbols are often transmitted with redundant symbols for error checking and/or correction.

### SUMMARY

In an aspect, a method includes: obtaining, by a first computer system, source data for transmission to a second computer system; generating, by the first computer system, first semantically encoded data representing the source data, where the first semantically encoded data is generated based on: a first computer knowledge base stored locally by the first computer system, and a second computer knowledge base shared between the first computer system and the second computer system; decoding, by the first computer system, the first semantically encoded data based on the second computer knowledge base to generate semantically decoded data; comparing, by the first computer system, the source data and the semantically decoded data; and selectively transmitting, by the first computer system, a pilot signal to the second computer system based on the comparison between the source data and the semantically decoded data.

Implementations of this aspect can include one or more of the following features.

In some implementations, the pilot signal can represent a modification to the second computer knowledge base.

In some implementations, at least one of the first computer knowledge base or the second computer knowledge base can include data representing a context of the source data.

In some implementations, the pilot signal can be transmitted to the second computer system in response to determining that a difference between the source data and the semantically decoded data is greater than a threshold.

In some implementations, the method can include: generating, by the first computer system, second semantically encoded data representing the semantically decoded data, where the first semantically encoded data is generated based on the first computer knowledge base; comparing, by the first computer system, the first semantically encoded data and the second semantically encoded data; selectively transmitting, by the first computer system, the pilot signal to the second computer system based on the comparison between the first semantically encoded data and the second semantically encoded data.

In some implementations, the pilot signal can be transmitted to the second computer system in response to determining that a difference between the first semantically encoded data and the second semantically encoded data is greater than a threshold.

In some implementations, the method can include: generating, by the first computer system, syntactically encoded data representing the first semantically encoded data; and transmitting, by the first computer system, the syntactically encoded data to the second computer system.

In some implementations, the syntactically encoded data can be transmitted to the second computer system via a wireless network.

In some implementations, the first computer system can be a user equipment (UE) of a wireless network.

In some implementations, the first computer system can be a base station of a wireless network.

In another aspect, a method includes: receiving, by a second computer system, syntactically encoded data from a first computer system; decoding, by the second computer system, the syntactically encoded data to obtain first semantically encoded data, where the semantically encoded data represents source data, where the first semantically encoded data is generated based on: a first computer knowledge base stored locally by the first computer system, and a second computer knowledge base shared between the first computer system and the second computer system; decoding, by the second computer system, the first semantically encoded data based on (i) the second computer knowledge base and (ii) a third computer knowledge base stored locally by the second computer system to generate first semantically decoded data; generating, by the second computer system, second semantically encoded data representing the first semantically decoded data, where the second semantically encoded data is generated based on the second computer knowledge base; comparing, by the second computer system, first semantically encoded data and the second semantically encoded data; and selectively requesting, by the second computer system, a pilot signal from the first computer system based on the comparison between the first semantically encoded data and the second semantically encoded data.

Implementations of this aspect can include one or more of the following features.

In some implementations, at least one of the first computer knowledge base or the second computer knowledge base can include data representing a context of the source data.

In some implementations, the pilot signal can represent a modification to the second computer knowledge base.

In some implementations, the pilot signal can be requested in response to determining that a difference between the first semantically encoded data and the second semantically encoded data is greater than a threshold.

In some implementations, the method can include: decoding, by the second computer system, the second semantically encoded data based on the second computer knowledge base to generate second semantically decoded data; comparing, by the second computer system, the first semantically decoded data and the second semantically decoded data; selectively requesting, by the second computer system, the pilot signal from the first computer system based on the comparison between the first semantically decoded data and the second semantically decoded data.

In some implementations, the pilot signal can be requested in response to determining that a difference between the first semantically decoded data and the second semantically decoded data is greater than a threshold.

In some implementations, the method can include determining the source data based on the first semantically decoded data.

In some implementations, the syntactically encoded data can be received from the first computer system via a wireless network.

In some implementations, the second computer system can be a user equipment (UE) of a wireless network.

In some implementations, the second computer system can be a base station of a wireless network.

In another aspect, a method includes: obtaining, by a first computer system, source data for transmission to a plurality of second computer systems; generating, by the first computer system, first semantically encoded data representing the source data, where the first semantically encoded data is generated based on: a first computer knowledge base stored locally by the first computer system, and a second computer knowledge base shared between the first computer system and the second computer systems; transmitting, by the first computer system, a first message representing the first semantically encoded data to each of the second computer systems; receiving, by the first computer system, a respective second message from each of the second computer systems, where each of the second messages represents a respective degree of semantic distortion determined by a respective one of the second computer systems based on the first message and the second computer knowledge base; and causing, by the first computer system, one or more of the second computer systems to update the second computer knowledge base based on the second messages.

In some implementations, at least one of the first computer knowledge base or the second computer knowledge base can include data representing a context of the source data.

In some implementations, the first message can be transmitted via a wireless network, and the second message can be received via a wireless network.

In some implementations, causing one or more of the second computer systems to update the second computer knowledge base can include causing the one or more second computer systems to update an instance of the second computer knowledge base stored by the one or more second computer systems.

In some implementations, the first computer system and the second computer systems can be communicatively coupled via a wireless network having at least one of: a tree configuration, a mesh configuration, a clustered configuration, or any combination thereof.

In some implementations, the first computer system can be a user equipment (UE) of a wireless network.

In some implementations, the first computer system can be a base station of a wireless network.

In another aspect, a method includes: receiving, by a second computer system, a plurality of first messages from a plurality of first computer systems, where each of the first messages represents respective semantically encoded data generated based on a computer knowledge base shared between the first computer systems and the second computer system; determining, by the second computer system, a degree of semantic distortion based on the first messages and the computer knowledge base; and causing, by the second computer system, one or more of the first computer systems to update the computer knowledge base based on the determined degree of semantic distortion.

Implementations of this aspect can include one or more of the following features.

In some implementations, the computer knowledge base can include data representing a context of communications between the second computer system and the plurality of first computer systems.

In some implementations, the plurality of first messages can be received via a wireless network.

In some implementations, causing one or more of the first computer systems to update the computer knowledge base can include causing the one or more first computer systems to update an instance of the computer knowledge base stored by the one or more first computer systems.

In some implementations, the first computer systems and the second computer system can be communicatively coupled via a wireless network having at least one of: a tree configuration, a mesh configuration, a clustered configuration, or any combination thereof.

In some implementations, the first computer system can be a user equipment (UE) of a wireless network.

In some implementations, the first computer system can be a base station of a wireless network.

In another aspect, a method includes: obtaining, by a first computer system, source data for transmission to a second computer system, where the source data includes at least one of video content, audio context, and/or text content; generating, by the first computer system, first semantically encoded data representing the source data, where the first semantically encoded data is generated based on a first computer knowledge base stored locally by the first computer system; generating, by the first computer system using an augmentation generator circuitry, a plurality of additional source data based on the source data, where each of the additional source data represents one or more respective modifications to the source data; generating, by the first computer using a semantic mirror circuit, a plurality of second semantically encoded data representing the additional source data, where the second semantically encoded data is generated based on a second computer knowledge base, and where the second computer knowledge base represents one or more respective modifications to the first computer knowledge base; comparing the first semantically encoded data and the plurality of second semantically encoded data; and selectively transmitting, by the first computer system, a pilot signal to the second computer system based on the comparison between the first semantically encoded data and the plurality of second semantically encoded data.

Implementations of this aspect can include one or more of the following features.

In some implementations, at least one of the first computer knowledge base or the second computer knowledge base can include data representing a context of the source data.

In some implementations, the pilot signal can represent a modification to a third computer knowledge base stored by second computer system.

In some implementations, the source data can include video content. Further, the plurality of additional source data can include one or more modifications to a frame rate, a resolution, or a frame of the video content.

In some implementations, the source data can include audio content. The plurality of additional source data can include one or more modifications to a sampling frequency or spectral composition of the audio content.

In some implementations, the source data can include text content. The plurality of additional source data can include one or more modifications to the text content.

In some implementations, the first computer system can be a user equipment (UE) of a wireless network.

In some implementations, the first computer system can be a base station of a wireless network.

In another aspect, a method includes: obtaining, by a first computer system, source data for transmission to a second computer system, where the source data includes at least one of video content, audio context, and/or text content; generating, by the first computer system, first semantically encoded data representing the source data, where the first semantically encoded data is generated based on a first computer knowledge base stored locally by the first computer system; generating, by the first computer system using an augmentation generator circuitry, a plurality of second semantically encoded data based on the first semantically encoded data, where each of the second semantically encoded data represents one or more respective modifications to the first semantically encoded data; decoding, by the first computer using a semantic mirror circuit, plurality of second semantically encoded data to obtain a plurality of semantically decoded data, where the second decoded data is generated based on a second computer knowledge base, and where the second computer knowledge base represents one or more respective modifications to the first computer knowledge base; comparing, by the first computer system, the source data and the plurality of semantically decoded data; and selectively transmitting, by the first computer system, a pilot signal to the second computer system based on the comparison between the source data and the plurality of semantically decoded data.

Implementations of this aspect can include one or more of the following features.

In some implementations, at least one of the first computer knowledge base or the second computer knowledge base can include data representing a context of the source data.

In some implementations, the pilot signal can represent a modification to a third computer knowledge base stored by second computer system.

In some implementations, the source data can include video content. The second semantically encoded data can represent one or more modifications to a frame rate, a resolution, or a frame of the video content.

In some implementations, the source data can include audio content. The plurality of second semantically encoded data can represent one or more modifications to a sampling frequency or spectral composition of the audio content.

In some implementations, the source data can include audio content. The plurality of additional source data can include one or more modifications to a sampling rate, bit rate, or spectral composition of the audio content.

In some implementations, the source data can include text content. The plurality of second semantically encoded data can represent one or more modifications to the text content.

In some implementations, the first computer system can be a user equipment (UE) of a wireless network.

In some implementations, the first computer system can be a base station of a wireless network.

In another aspect, a method includes: obtaining, by a first computer system, sensor data regarding an operation of an autonomous vehicle; determining, by the first computer system, a semantic representation of an operation state of the autonomous vehicle based on the sensor data and a computer knowledge base, where the computer knowledge base includes data shared between the first computer system and one or more second computer systems; determining, by the first computer system, a semantic representation of a plurality of additional operation states of the autonomous vehicle based on the sensor data and the computer knowledge base, where each of the additional operation states represents a respective predicted operation state of the autonomous vehicle at a respective future time; generating, by the first computer systems, a plurality of predicted actions of the autonomous vehicle based on the semantic representation of the operation state and the semantic representation of the plurality of additional operation states, where the plurality of prediction actions include one or more predicted trajectories of the autonomous vehicle; determining, by the first computer system, an action performed by the autonomous vehicle based on the sensor data; comparing, by the first computer system, the action performed by the autonomous vehicle and the plurality of predicted actions of the autonomous vehicle; and selectively updating the computer knowledge base in response to the comparison between the action performed by the autonomous vehicle and the plurality of predicted actions of the autonomous vehicle, including transmitting a message to the one or more second computer systems to update the data shared between the first computer system and the one or more second computer systems.

Implementations of this aspect can include one or more of the following features.

In some implementations, comparing the action performed by the autonomous vehicle and the plurality of predicted actions of the autonomous vehicle can include determining a degree of semantic distortion between a semantic representation of the action performed by the autonomous vehicle and a semantic representation of the plurality of predicted actions of the autonomous vehicle.

In some implementations, the additional operation states can represent a sequence of predicted operation states of the autonomous vehicle during a sequence of future time slots.

In some implementations, the computer knowledge base can include data representing sensor data previously obtained by the autonomous vehicle and one or more actions previously performed by the autonomous vehicle.

In some implementations, the computer knowledge base can include data representing sensor data previously obtained by one or more additional autonomous vehicles and one or more actions previously performed by the one or more additional autonomous vehicles.

In some implementations, the computer knowledge base can include data representing one or more static features of an environment of the autonomous vehicle.

In some implementations, the data representing one or more static features of an environment of the autonomous vehicle can include data representing at least one of a map of the environment, a road in the environment, or a building in the environment.

In some implementations, the computer knowledge base can include data representing one or more dynamic features of an environment of the autonomous vehicle.

In some implementations, the data representing one or more dynamic features of an environment of the autonomous vehicle can include data representing at least one a vehicle in the environment, a pedestrian in the environment, or a signal state of a traffic signal in the environment.

In another aspect, an apparatus includes one or more processors configured to perform any of the methods described herein.

In another aspect, one or more non-transitory computer readable media store instructions that, when executed by one or more processors, cause the one or more processors to perform to perform any of the methods described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example system for providing a D-SMCE.

FIG. 3 illustrates example local knowledge bases and a shared knowledge base.

FIG. 4 illustrates an example transmitter device having an internal loop for performing semantic communication operations with a Shared KB.

FIG. 5 illustrates an example receiver device having an internal loop for performing semantic communication operations with a Shared KB.

FIGS. 6 and 7 illustrate example systems having an external loop between a transmitting device and a receiving device.

FIG. 8 illustrates example communications between a single transmitter device and multiple receiver devices.

FIG. 9 illustrates example communications between multiple transmitter devices with a single respective receiver device.

FIG. 10 illustrates example communications between multiple transmitter devices with multiple respective receiver devices.

FIG. 11 illustrates example communications between multiple transmitter devices with multiple respective receiver devices.

FIG. 12 illustrates an example system including a semantic control plane with augmentation.

FIG. 13 illustrates an example operation of the system shown in FIG. 12.

FIG. 14 illustrates an example augmentation generator implemented using an auto-encoder.

FIG. 15 illustrates an example semantic mirror and augmentation generator implemented using a variational autoencoder.

FIG. 16 illustrates another example system including a semantic control plane with augmentation.

FIG. 17 illustrates an example augmentation generator implemented using an auto-encoder.

FIG. 18 illustrates an semantic mirror and augmentation generator implemented using a variational encoder.

FIG. 19 illustrates an example system having a semantic control plane for performing task-oriented communication.

FIG. 20 illustrates an example SDI measurement module.

FIGS. 21A-21G illustrate flowcharts of example methods, according to some implementations.

FIG. 22 illustrates an example user equipment (UE), according to some implementations.

FIG. 23 illustrates an example access node, according to some implementations.

### DETAILED DESCRIPTION

In traditional wireless communications, communication quality is typically measured based on the number of symbols recoverable/recovered by the receiving device. For a given set of encoded symbols, increasing the number of symbols recoverable/recovered at the receiving device means transmitting more redundant symbols for error checking and/or correction. This can increase the consumption of network resources and the complexity of devices.

In contrast to traditional wireless communications, semantic communications focus on conveying the desired meaning (“perception” or “context”) in the transmitted symbols. A traditional wireless receiver attempts to recover information objectively encoded in each individual symbol, whereas a semantic wireless receiver attempts to infer the subjective perception that the transmitter device intends to convey. For example, when a transmitting device wants to convey weather information to a receiving device, instead of transmitting the exact temperature value, the transmitting device can perceive that the weather is cold, warm, or hot, and transmit its perception of the weather to the receiving device in semantic messages. Correspondingly, the receiving device can interpret the weather condition based on the semantic information received from the transmitting device. A communications session for transmitting and receiving semantic messages can be referred to as a semantic communications session. The interpretation by the transmitting device can be referred to as semantic encoding, while the interpretation by the receiving device can be referred to as semantic decoding. When the transmitting device and the receiving device interprets the same semantic information differently, semantic distortion can occur.

In the above example of weather reporting, the semantic encoding and decoding of the weather condition rely on semantic knowledge of the transmitting device and the receiving device, respectively. The semantic knowledge can be stored in one or more storage devices, referred to as knowledge bases (KBs), in the form of, e.g., data indicating a correspondence between a temperature value and a weather condition. To ensure that the receiving device interprets the semantic information as intended by the transmitting device and vice versa to ensure that the transmitting device provides the semantic information in such a way that it suits the receiving devices expected interpretation, the transmitting device and the receiving device may have their respective semantic knowledge synchronized. Otherwise, for a given temperature value (e.g., 15° C.) transmitted, if the weather condition interpreted by the transmitting device (e.g., warm) is different from that interpreted by the receiving device (e.g., cold), then the semantic communications session can be considered to suffer a semantic distortion that negatively affects the communication quality.

The semantic distortion is conceptually different from the symbol errors caused by noise and interference (often measured as bit error rate [BER], frame error rate [FER], block error rate [BLER], or packet error rate [PER]) in traditional wireless communications. In traditional wireless communications, the protocol for encoding and decoding the information into symbols is known to both the transmitting device and the receiving device regardless of the actual meaning of the application information. That is, the errors at the network layers, including media access control (MAC) and physical (PHY) layers, can be decoupled from the error at the application layer. By contrast, in semantic communications, because the transmitting device and the receiving device seek knowledge from the application to interpret the symbols, the application layer is not decoupled from the network layers when semantic distortion is measured. Rather, semantic distortion can be a result of KB difference between the transmitting device and the receiving device or misinterpretation of the meaning of information due to environmental changes or incomplete observation. Accordingly, it is desirable for the network layer to receive feedback in one or more loops from the application such that the semantic communication over a network is aligned with the execution of the application.

As described in detail below, implementations of this disclosure provide one or more mechanisms for apparatuses in semantic communications sessions to synchronize KBs, address semantic distortions, and coordinate with other entities in the network using a distributed control entity. With one or more features provided herein, a semantic communications network can be formed with improved communication quality, efficiency, and scalability, and can be used in many applications that require complex network structure and high data speed.

As an example, a wireless communication system is configured to send and receive semantic data. In general, semantic data represents a desired meaning of a given coded message based on a context of the given coded message for that transmission. The semantic meaning is determined based on semantic models that are trained for the device performing the communication, the device receiving the communication, the type of data being communicated, and so forth.

In some implementations, a Distributed Semantic Measurement and Control Entity (D-SMCE) can be configured to monitor the communications between two systems and determine a degree of semantic distortion of those communications (also referred to as semantic distortion index, SDI), and to perform operations to mitigate semantic distortion (e.g., by causing one or more systems to modify the knowledge base(s) used for semantic communication to better conform with the other system(s)). As an example, the degree of semantic distortion can refer to the deviation between (i) the transmitting system's desired meaning of a given coded message, and (ii) the receiving system's interpretation of the coded message. In particular, a D-SMCE can be implemented on the transmitting system and/or on the receiving system, rather than on a centralized system (e.g., a centralized server that is separate and distinct from the transmitting system and the receiving system). This can be advantageous, for example, in allowing systems to monitor and regulate semantic communications between them, without requiring the participation of a third system. In some implementations, the D-SMCE can be implemented using software, hardware, or a combination thereof on a transmitting system and/or a receiving system.

Further, in some implementations, a wireless communication system can generate semantic data for specific types of use cases. For example, a wireless communication system can generate semantic data specifically to represent video content, audio content, and/or text content. As another example, a wireless communication system can generate semantic data specifically to represent data pertaining to the operation of an autonomous vehicle (e.g., sensor data, telemetry data, trajectory data, etc.). In particular, a wireless communications system can determine the degree of semantic distortion in these contexts by generating noisy semantic data (e.g., using an “augmentation generator” or “augmentation generator circuitry”) and decoding the semantic data using a noisy decoder (e.g., using a “semantic decoder mirror,” “semantic decoder mirror circuitry”, or “semantic mirror circuitry”). This can be advantageous, for example, in allowing systems to test the robustness of the semantic encoding and decoding operations in a wide array of contexts specific to those use cases.

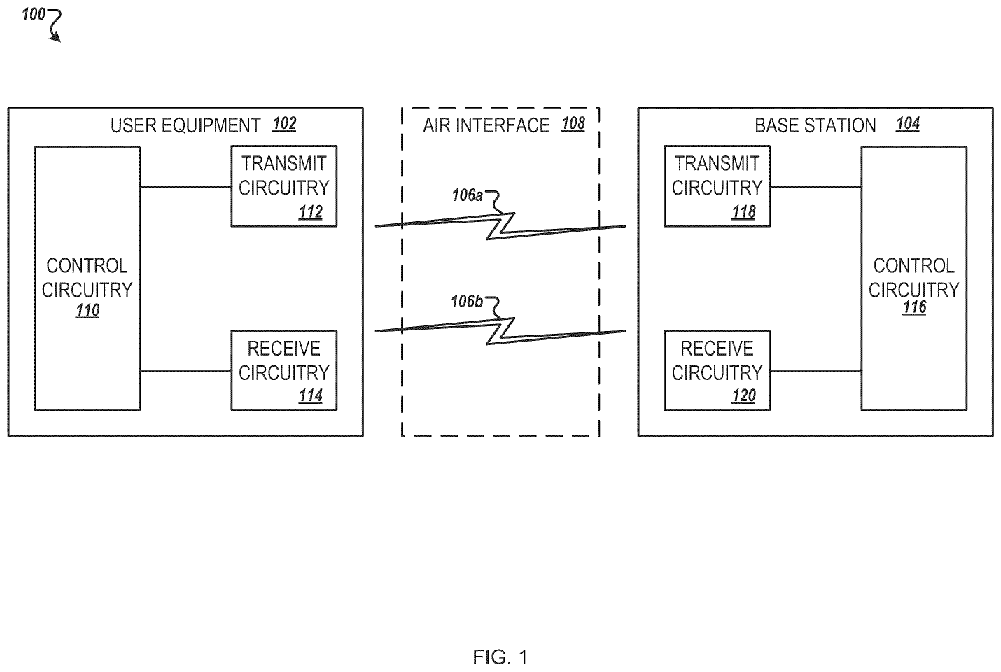

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can be configured to encode data and/or decode data for semantic communication. As another example, the control circuitry 110 can be configured determine a degree of semantic distortion between two or more devices, and perform operations to reduce the degree of semantic distortion.

The transmit circuitry 112 can perform various operations described in this specification. For example, the transmit circuitry 112 can be configured to transmit data (e.g., semantically encoded data) for semantic communication with one or more other devices. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can be configured to receive data (e.g., semantically encoded data) for semantic communication with one or more other devices. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

### Example Distributed Semantic Measurement and Control Entities:

In general, a Distributed Semantic Measurement and Control Entity (D-SMCE) can be configured to monitor the communications between two systems and determine a degree of semantic distortion of those communications. In some implementation, D-SMCE can be implemented on the transmitting system and/or on the receiving system, rather than on a centralized system (e.g., a centralized server that is separate and distinct from the transmitting system and the receiving system). This can be advantageous, for example, in allowing systems to monitor and regulate semantic communications between them, without requiring the participation of a third system.

Further, the role of a D-SMCE can vary depending on the state of a semantic communications session. For example, at the initiation of a semantic communications session, a D-SMCE can manage a KB (e.g., local KB stored on a device, a shared KB that is shared among multiple devices, etc.), provide an interface to register device capabilities for semantic communication, and/or provide an interface and protocols to synchronize local KBs with the global or shared KB through a semantic pilot sequence. During an active semantic communications session, a D-SMCE can perform SMCE measurement to track semantic distortion during the session, and/or provide an interface to register information about session-specific semantic distortion metrics, e.g., by registering a metric function or metric values. After a semantic communications session finishes, a D-SMCE can keep the history of the session in a semantic repository or an operations and maintenance center (OMC) of the network, call the history of application before executing admission control, and/or decide to share or not to share the history of the session with an application controller.

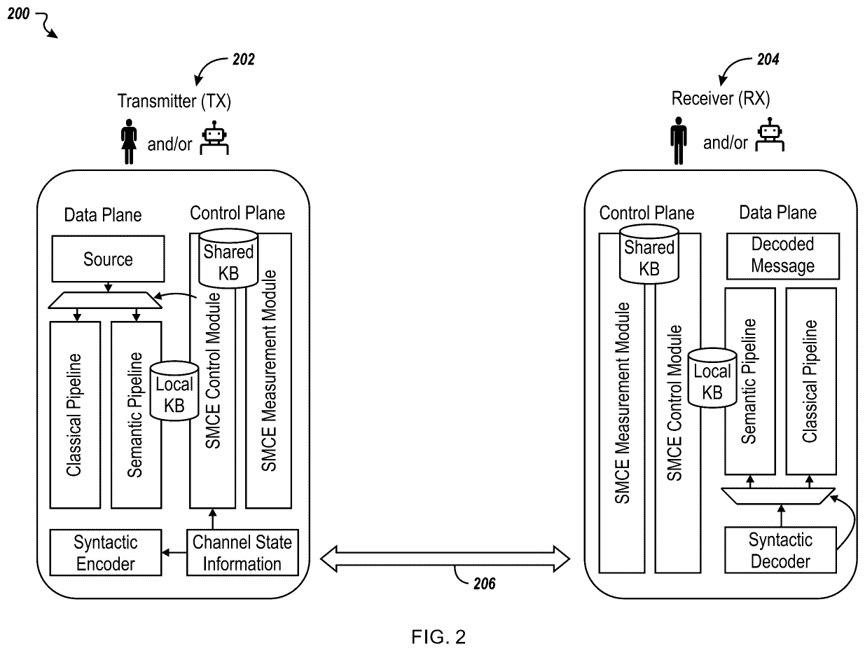

An example system 200 for providing a D-SMCE is shown in FIG. 2. The system 200 include a transmitter device 202 (e.g., for transmitting data) and a receiver device 204 (e.g., for receiving data from the transmitter device 202). In some implementations, the transmitter device 202 and/or the receiver device 204 can be a UE 102 or a base station 104 (e.g., as described with reference to FIG. 1). Although system 200 describes devices as being a transmitter device 202 or a receiver device 204, in practice, a device can both transmit and receive data, either concurrently in an alternating manner.

In some implementations, the transmitter device 202 and/or the receiver device 204 can communicate with one another via a network 206, such as a peer-to-peer (P2P) network, a mesh network, a clustered network, or any other type of network. Further, each of the transmitter device 202 and/or the receiver device 204 can be used or controlled by a human user, a machine (e.g., a computer system), or a combination thereof.

In general, each of the transmitter device 202 and/or the receiver device 204 has two planes, a data plane and a semantic control plane. The data plane is responsible for the transmission of source data with semantic encoding. The semantic control plane (including a SMCE control module and SMCE measurement module) is responsible handling any mismatch (e.g., a mismatch between the source data and the interpretation of the semantic encoded representation of the source data), and resolving any conflict among the devices.

Further, each device has, in parallel, “classical” data and control planes, called “syntactic encoder” and “syntactic control plane.” There are two data plane pipelines for semantic and classical source coding, where the elements of the syntactic layers (e.g., MAC and L1) are adjusted in accordance to the source coding. Switching among pipelines is performed by a D-SMCE control module based on feedback/information about the communication channel.

Semantic and classical pipelines are responsible to form the packets and frames to be fed to the communication system (or “syntactic encoder”).

In general, the transmitter device 202 semantically encodes source data using a knowledge base to obtain a semantically encoded representation of the source data. This semantic encoded data can represent, for example, the underlying meaning of the source data, but does not necessarily include the source data in its entirety. Further, the knowledge base can include a semantic model that represents the context of the source data, the manner in which the source data is collected or generated, the manner in which the source data is to be transmitted, the manner in which the source data will be used, and/or any information relating to the nature of the source data.

Further, the receiver device 204 receives the semantically encoded data, and decodes the semantically encoded data using a knowledge base to obtain a representation of the original source data. In some implementations, the knowledge base can be the same as the knowledge base that was used by the transmitter device 202 to generate the semantically encoded data. In some implementations, the knowledge base can be different, at least some respects, from the knowledge base that was used by the transmitter device 202 to generate the semantically encoded data.

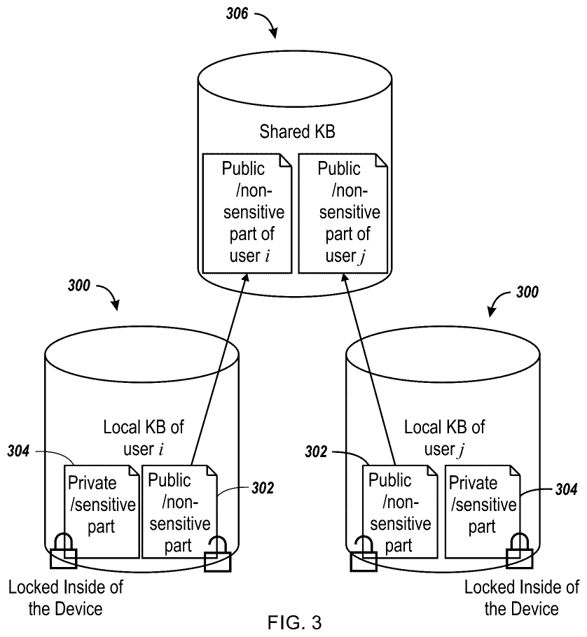

In some implementations, each of the device can include a local knowledge base (L-KB) that is locally stored by that device and used for semantically encoding and/or decoding data by that device. For example, as shown in FIG. 3, a L-KB 300 can include two parts, a public/non-sensitive part 302 and a private/sensitive part 304. In general, the public/non-sensitive part 302 does not include any sensitive or private information by a user and can be shared with others. The private/sensitive part 304 includes a information that a user deems to be sensitive or private information, and is not shared with others.

As shown in FIG. 3, at the initialization phase of transmission (also referred to as the semantic synchronization phase), the two (or more) users agree on a shared knowledge 306 (Shared KB) that includes data from the public/non-sensitive parts 302 of the L-KB 300. However, the L-KBs 300 of the devices retain their respective private/sensitive parts 304, and do not provide the information therein to the Shared KB 306.

In general, the users of the devices can exhibit different behavior during their communication.

In some implementations, the users can be can be friendly and cooperative with one another. For example, the users can openly share all of their knowledge/data with one another.

Further, if their L-KBs 300 become outdated or noisy, the users can update their L-KBs 300 in the negotiation and synchronization phases. In this context, there may be no need to introduce incentive mechanisms for sharing content of the L-KBs 300.

In some implementations, the users may be cooperative but reserved. For example, both sides can be cooperative and share their public/non-sensitive data with one another. However, they may refrain from sharing their L-KBs 300 during a communications session. Here, the incentive mechanisms (e.g., providing a reward or reducing the cost of communication), can be useful for both sides. In some implementations, users can transition from the cooperative but reserved relationship to a friendly and cooperative relationship over time.

In some implementations, the system may be subject to a cyber/poisoned attack by one or more malicious users. For instance, the transmitter device 202 and/or the receiver device 204 may be subject to a cyberattack or poisoned attack. As an example, the Shared KB 306 and/or the L-KBs 300 may be attacked or poisoned. Since semantic communication inherits all attack aspects of artificial intelligence (AI) and/or machine learning (ML) algorithms, semantic communication can be a subject of any type of AI/ML attack during the training and inference phases. If the offline and training phase is not part of the session, D-SMCE may not be able to directly act. However, semantic distortion can be used to highlight the outliers attacked during the offline phase. In general, the inference attacks during the communication session are considered as adversarial attack of MLs in the inference phase (decision making).

In some implementation, the users of the transmitter device 202 and/or receiver device 204 may be malicious users. For example, the users and/or their devices may not cooperative, and in some cases may intentionally aim to destroy the other user's perception of semantic communication. The behavior of this class of users can be seen as outliers, jammers, or eavesdroppers. If the L-KB 300 of one device is poised and attacked, this attack can be propagated to all other devices.

In each of these situations, it is beneficial to determine the degree of semantic of the communication between the two devices in order to mitigate issues that may arise (either due to intentional behavior and/or malicious behavior) during the communication.

In general, semantic communication may refer to different source data categories such as image, video, audio, voice, sensor data, formal language-based content, ASCII text, or any other type of data. As an example, semantic communication can be used to exchange video and/or audio in a more efficient manner. For instance, a transmitter device can use semantic communication to extract and transmit the relevant information (e.g., semantics) from source data (e.g., source data representing video and/or audio), using knowledge that is available at the transmitter device. Further, the transmitter device can provide the semantics (e.g., the semantically encoded data) to the receiver device, rather than transmitting the source data itself. Upon receiving the semantics, the receiver device can reconstruct the source data by exploiting knowledge available at the receiver device (e.g., in order to semantically decode the received data).

In some implementations, switch between semantic and classical communication (e.g., (e.g., during a communication session) may require changes in the frame processing, frame period (or timing), and frame types, which collectively may be referred to as the “pipeline”. In some implementations, switching can be triggered (c.f. Section 1) and mitigated in its transient effects by the transmitter device's D-SMCE control module based on channel state information and/or by receiver device's request.

In the example use cases described below, a device's L-KB includes the knowledge that is used for semantic communication. For example, a L-KB can include information regarding:
AI/ML model types, versions, and (hyper-)parameters for extraction and reconstruction, and
Side information for extraction (e.g., relevance and prioritization of latent features), and reconstruction (e.g. source frame and situational context),

As described in further detail below, some part of the information in the L-KB may be public (e.g., non-private/non-sensitive) and other data may be considered private (e.g., strictly private). Thus, the Shared KB can hold the public information of all devices participating in the communication session.

Further, in some implementations, inconsistencies in the Local KBs and aging of information in the Shared KBs across UEs/devices may arise, which can adversely affect the accuracy (and in some cases, cause failure) of semantic communication.

In general, a D-SMCE can be used to detect semantic distortion caused by inconsistencies in and aging of distributed shared knowledge in Shared KBs, re-sync Shared KBs during a session, and/or perform the related measuring and controlling tasks in a fully distributed manner.

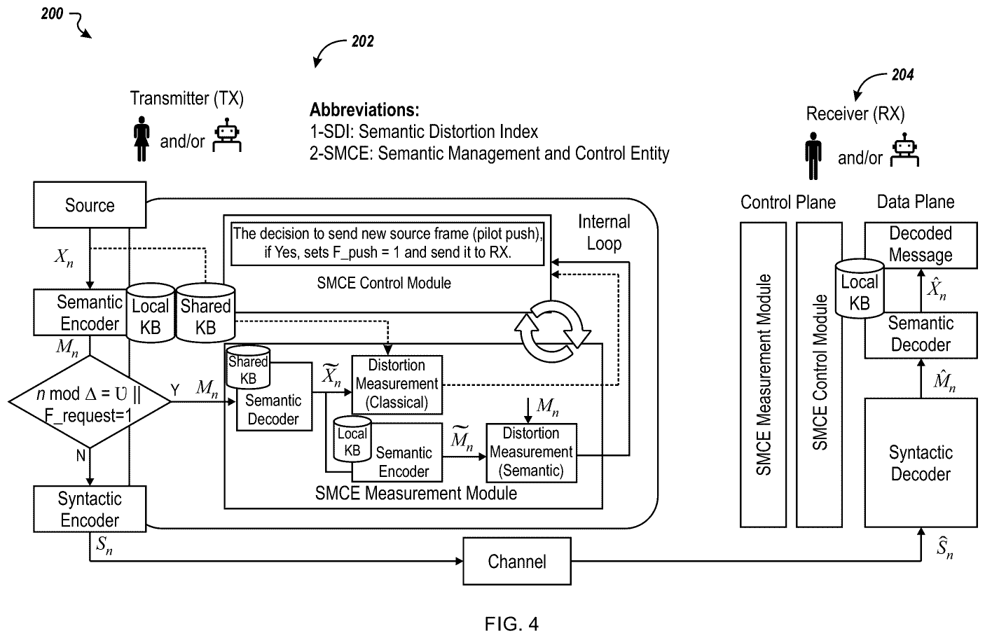

In some implementations, the transmitter device 202 can include an internal loop for performing semantic communication operations with a Shared KB (e.g., to exchange video and/or audio content). An example system 200 having this configuration is shown in FIG. 4.

In general, the internal loop is part of each transmitter device 202 (TX) and each receiver device 204 (RX) and includes at least two components: a SMCE control module and SMCE measurement module. Further, in this example, there is a time slot Δₜ when the semantic frames will be sent from TX to RX.

An example procedure for operating the internal loop includes the following actions.

For video and audio applications, each communication session is devised into a set of subsequent video (and audio) frames: Xₙ∈{X₁, X₂, . . . X_{N}} where periodically (n mod Δ=0) a frame Xₙ is picked by the transmitter.
1. For each Xₙ: n mod Δ=0, the transmitter's SMCE measurement module can:
   a. Synthesize a frame Mₙ→ [symbol] (using the transmitter-side Shared KB) and (optionally) calculate the classical distortion d( [symbol] , Xₙ) or a distortion metric based on classical quality measures like PSNR,
   b. Extract [symbol] → [symbol] (using the transmitter-side Local KB) and calculate the semantic distortion d( [symbol] , Mₙ).
   c. If there are suspicious outliers, integrity analysis and if necessary the appropriate measures can be initiated to counter-act a potentially ongoing malicious attack and to restore intact KBs.
2. After each time slot n, the transmitter evaluates whether the semantic communication is accurate or successful. The evaluation is performed by transmitter's SMCE control module and in accordance to certain decision rules for thresholds and selection of distortion metrics.
   a. If TX evaluates the semantic communication as accurate or successful, there is no need to initiate with the external loop between TX and RX.
   b. If TX evaluates the semantic communication as inaccurate or unsuccessful, TX triggers the external loop:
      i. TX sends one of its own frames (e.g., a new source frame before semantic analysis) as the new pilot message to RX.
      ii. RX responds with SDI_{RX}=f(d (\hat{\tilde{M}}, \hat{M})) and if SDI_{RX}=f(d (\hat{\tilde{M}}, \hat{M}))≤S_{threshold}^{TX} at TX is sufficiently small or in case of timeout, TX will stop pushing pilots and TX may update the TX Shared KB.

In general, the decision rules for accuracy evaluation can be optimized for the device's compute resources and energy budget. Threshold setting and down-selection of the distortion metrics can be based on the type of application and type and version of the semantic coder.

Further, the initiation of the external loop is performed on the transmitter-side. Hence, this may be referred to as a “pilot push.”

In some implementations, the decision on updating the TX Shared KB can be taken by the TX and is not enforced by the counter-part RX. Similarly, the decision on updating the RX Shared KB can taken by the RX and is not enforced by the counter-part TX.

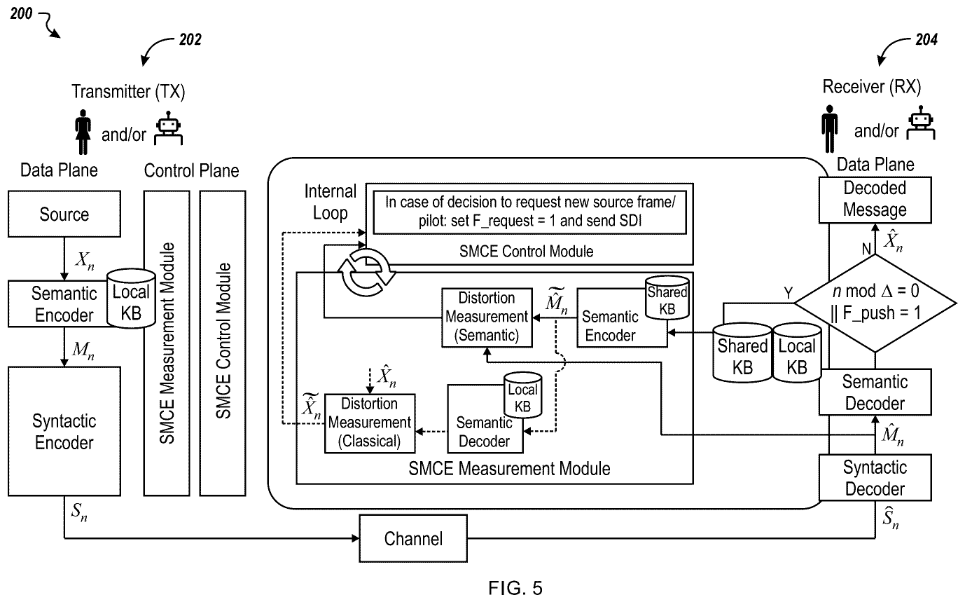

In some implementations, the receiver device 204 can include an internal loop for performing semantic communication operations with a Shared KB (e.g., to exchange video and/or audio content). An example system 200 having this configuration is shown in FIG. 5.

In general, the internal loop is part of each transmitter device 202 (TX) and each receiver device 204 (RX) and includes at least two components: a SMCE control module and SMCE measurement module. Further, in this example, there is a time slot Δₜ when the semantic frames will be sent from TX to RX.

An example procedure for operating the internal loop includes the following actions.

For video and audio applications, each communication session is devised into a set of subsequent video (and audio) frames: Xₙ∈{X₁, X₂, . . . X_{N}} where periodically (n mod Δ=0) a frame Xₙ is picked by the transmitter.

On the receiver's side, a session includes of a set of subsequent semantic frames recovered after the passage through the channel: \hat{M}ₙ∈{\hat{M}₁, . . . , \hat{M}_{N}} where periodically (n mod Δ=0) a frame \hat{M}ₙ is picked by the receiver.

1. For each \hat{M}ₙ: n mod Δ=0, the receiver's SMCE measurement module can:
a. After the receiver has synthesized \hat{M}ₙ→\hat{X}ₙ, re-extract the semantic frame Xₙ→\hat{\tilde{M}}ₙ, and calculate the semantic distortion d ( [symbol] ),
b. If there are suspicious outliers, integrity analysis and if necessary the appropriate measures can be initiated to counter-act a potentially ongoing malicious attack and to
restore intact KBs.
c. Optionally, synthesize [symbol] → [symbol] , and calculate the classical distortion d( [symbol] )

2. After each time slot n, the receiver evaluates whether the semantic communication is accurate or successful. The evaluation happens in the receiver's SMCE control module and in accordance to certain decision rules for thresholds and selection of distortion metrics.
a. If semantic communication is considered successful, there is no need to initiate the external loop between TX and RX.
b. If semantic communication is considered unsuccessful, RX triggers the external loop and:
   i. requests a new pilot (e.g., by requesting a new source frame for reconstruction) and sends SDI_{RX}=f(d(\hat{\tilde{M}}, \hat{M})).
   ii. TX selects and sends one of its own frames (e.g., a new source frame before semantic analysis) as the new pilot message to RX.
   iii. RX responds with SDI_{RX}=f(d(\hat{\tilde{M}}, \hat{M})) and if SDI_{RX}=f(d((\hat{\tilde{M}}, \hat{M})) SDI_{threshold}^{RX}, RX can update its RX Shared KB, and will stop requesting a new pilot.
   iv. If the TX received SDI_{RX}≤SDI_{threshold}^{TX} is sufficiently small, TX can update its TX Shared KB.

The decision rules for accuracy evaluation can be optimized for the device's compute resources and energy budget. Threshold setting and down-selection of the distortion metrics can be based on the type of application and type and version of the semantic coder.

Further, the initiation of the external loop is performed on the receiver-side, and hence may be referred to as a “pilot request.”

In some implementations, the decision on updating the TX Shared KB can be taken by the TX and is not enforced by the counter-part RX. Similarly, the decision on updating the RX Shared KB can be taken by the RX and is not enforced by the counter-part TX.

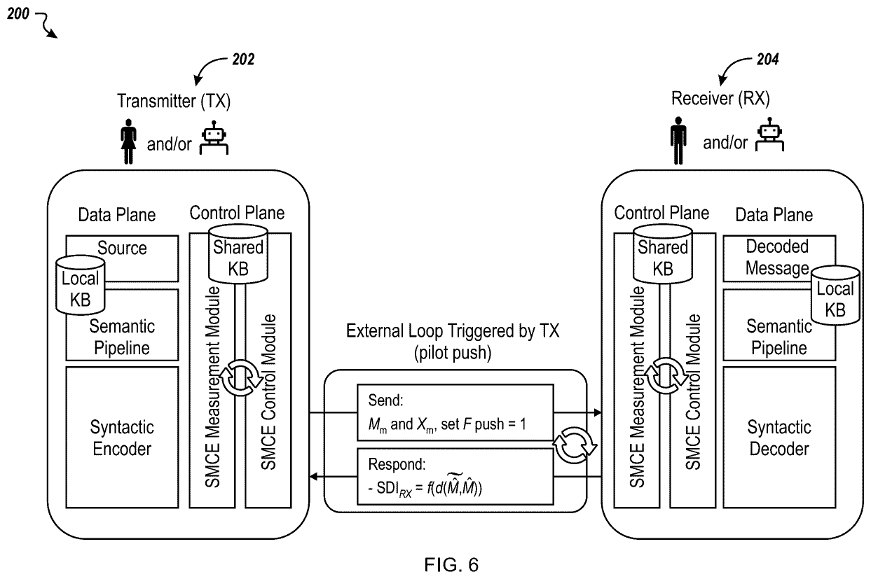

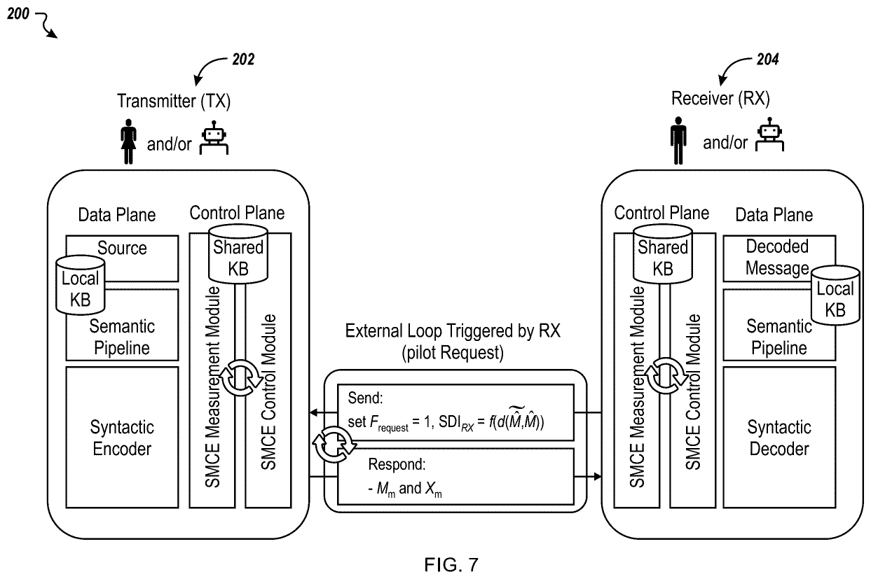

In some implementations, an external loop can be implemented between the TX and RX, can be initiated by the TX (e.g., as shown in FIG. 6) or by the RX (e.g., as shown in FIG. 7).

In general, the external loop can run in two modes: periodic and event-triggered.

In the periodic mode, for each Xₘ: m mod (n·Δ)=0 the transmitter shares Mₘ and Xₘ as a pilot with the receiver. In this case, Fₚᵤₛₕ is 1.

In the event-triggered mode, the transmitter can decide to push Mₘ and Xₘ upon its classical d( [symbol] , Xₘ) and/or on its semantic d( [symbol] , Mₘ) distortion metric. The transmitter sets Fₚᵤₛₕ=1 and sends Mₘ and Xₘ as a pilot. The RX will check its SDI=f(d( [symbol] , \hat{M}ₘ)) for that frame with the new pilot sent by TX and may accept the pilot.

The following actions can be performed based on the (new) RX SDI value:
1. If a new RX SDI value has improved, RX and TX can update their Shared KBs (and if applicable update their Local KBs).
2. If there are new features that can be shared among TX and RX, they can start updating their Local KBs.
3. If there is a need to communicate with the application controller to change the application parameters, this action can be initiated here.

Based on their internal loops, both the TX (pilot push) and RX (pilot request) can trigger the external loop between TX and RX devices. This can happen simultaneously (or nearly simultaneously), or not asynchronously.

In the bilateral case, updating the TX Shared KBs can be the responsibility and in the scope of TX and may not enforced by the counter-part RX. Similarly, updating the RX Shared KBs can be the responsibility and in the scope of TX and may not enforced by the counter-part TX.

In some implementations, switching between TX vs. RX external loop triggering can be performed in a soft manner (e.g., there is no a priori priority between RX and TX in the distributed scenario).

In some implementations, RX and TX can adjust their own thresholds and timings for triggering their internal or the external loop, as well as for updating their Shared KBs.

In some implementations, devices can mutually agree on orchestration. For example, either both of the TX and RX, or none, updates their Shared KBs upon successful stop of the external loop, and TX and RX agree on aligned parameter sets (e.g. on the external loop time-out or on the RX SDI threshold).

In the examples shown in FIGS. 2-6, a single transmitter device communicates with a single receiver device. However, in general, any number of transmitter devices (e.g., one, two three, or more) can communicate with any number of receiver devices (e.g., one, two, three, or more).

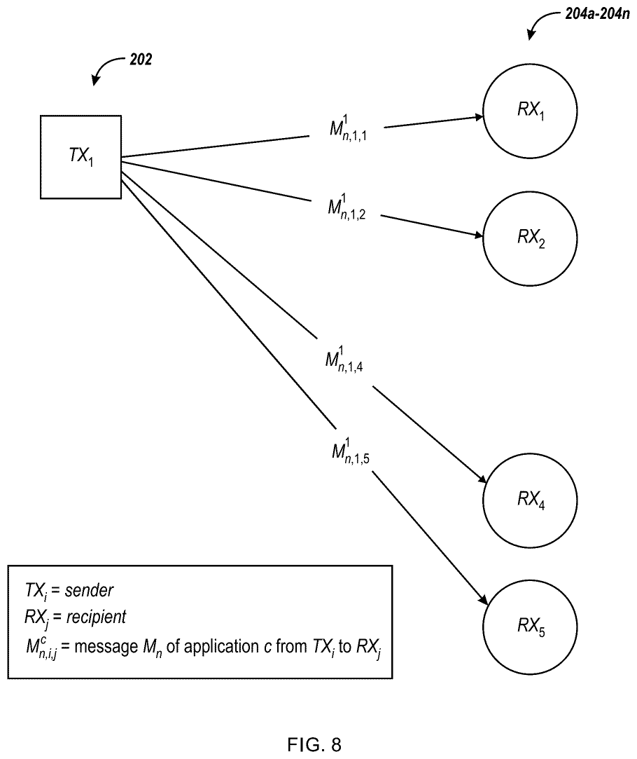

As an example, as shown in FIG. 8, a single transmitter device 202 can communicate with multiple receiver devices 204a-n. In this example arrangement, a single TX₁ transmits messages M_{n,1,j}¹⁰f application 1 to multiple RXⱼ,j={1,2,4,5}.

The TX₁ triggers the external loop in pilot push case, and RXⱼ,j={1,2,4,5} trigger the external loop in pilot request case.

As there are for application 1 potentially four different RX SDI values from RXⱼ,j∈{1,2,4,5}, the following resolution options exist:

Option 1—RX-specific pilots: TX₁ forms two clusters of RX SDI values: favorable or non-favorable for the pilot. TX₁ stores the pilot for the in-favor RXₖ, k⊆{1,2,4,5} in its Shared KB and asks the in-favor RXₖ to update their Shared KBs (if applicable update of the Local KBs). For the remaining RXₗ:RXⱼ\RXₖ, TX₁ can push new pilots until all RXⱼ,j={1,2,4,5} have favorable pilots.

Option 2—“Root Cause Elimination”: TX₁ takes actions to help eliminate the root cause to the achieve consistent RX SDI values.

Option 3—Decision: Min, mean, max, weighted average RX SDI w.r.t. RXⱼ,j={1,2,4,5} are calculated. Based on the RX SDI data, TX₁ updates its Shared KB and asks the RXⱼ,j={1,2,4,5} to update their Shared KBs (and if applicable update Local KBs).

Option 4—Federated RX SDI: TX₁ is the federating learning server for the weights for a weighted average RX SDI. Based this federated RX SDI, TX₁ initiates re-sync and the RXⱼ,j={1,2,4,5} Shared KBs (and if applicable update Local KBs).

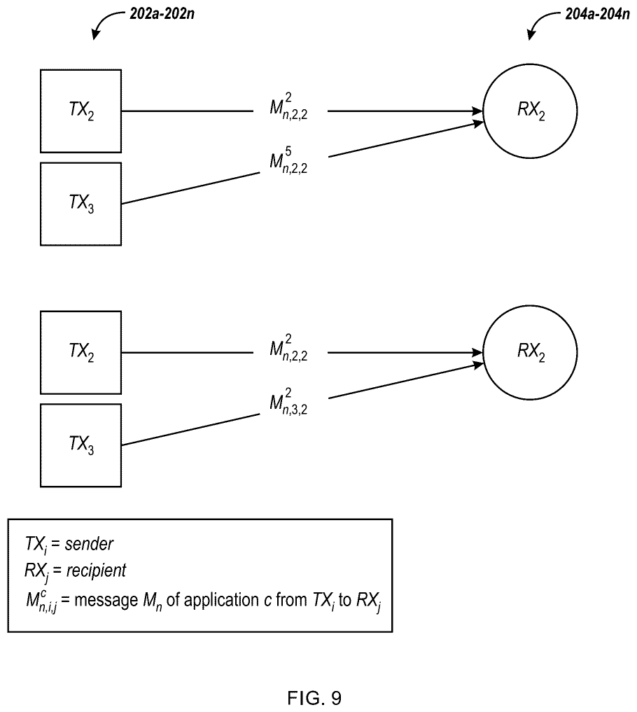

As another example, as shown in FIG. 9, a multiple transmitter devices 202a-n can communicate with a single respective receiver device 204a-n.

In this example, multiple TXᵢ∈{2,3} messages M_{n,i,2}^{c} of differing applications c∈{2,5}(multi-bilateral) or transmit messages M_{n,i,2}² of application 2 (conflict) to a single RX₂.

In general, TXᵢ trigger the external loop in pilot push case, and RX_{J} trigger the external loop in pilot request case.

Multi-bilateral: TXᵢ, i∈{2,3} send messages M_{n,i,2}^{c} of differing applications c∈{2,5}. This corresponds to multiple bilateral cases. Each of the TXᵢ, i∈{2,3} will initiate re-sync of the RX₂ Shared KBs for applications c∈{2,5} with its Shared KB (if applicable also update of Local

Conflict: TXᵢ, i∈{2,3} send messages M_{n,i,2}² of the same application 2 (e.g. for reliability). There is a chance that the TXᵢ provide differing pilots to the same RX₂. RX₂ selects a pilot and responds with RX SDI for that selected pilot. RX₂ can track min, mean, max, weighted average RX SDI for all pilots received. Further, RX₂ can initiate re-sync of the RX₂ Shared KBs with the TXᵢ, i∈{2,3} Shared KBs for application 2 (if applicable also update of Local KBs).

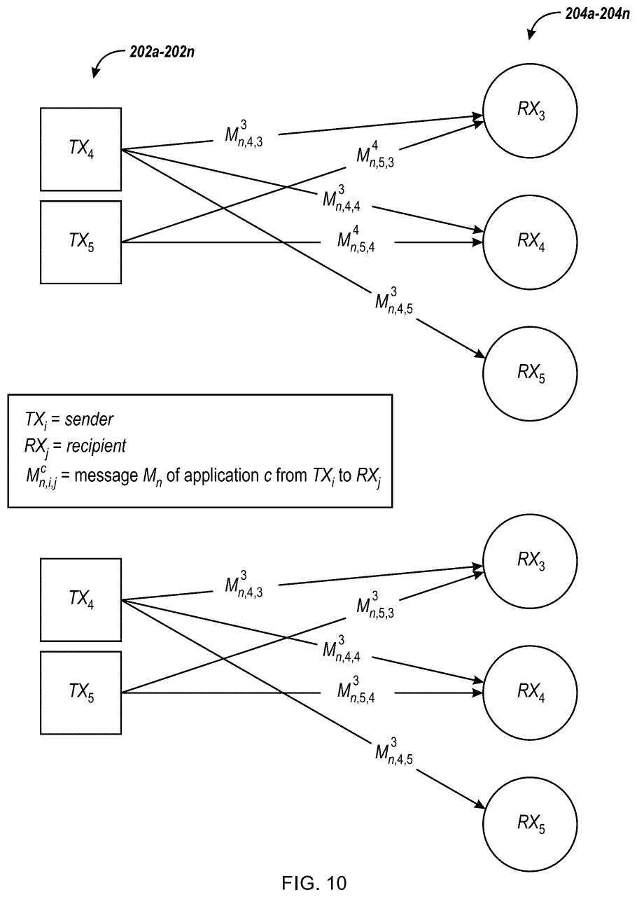

As another example, as shown in FIG. 10, a multiple transmitter devices 202a-n can communicate with a multiple respective receiver device 204a-n. In this example arrangement, multiple TXᵢ, i∈{4,5} transmit messages M_{n,i,j}^{c} of differing applications c∈{3,4} or messages M_{n,i,j}³ of same application 3 to RXⱼ,j={3,4,5}.

TXᵢ trigger the external loop in pilot push case, and RXⱼ trigger the external loop in pilot request case.

Differing applications: TX₁, ∈{4,5} transmit messages M_{n,i,j}^{c} of differing applications c∈{3,4} to RXⱼ, i∈{3,4,5}. There are |TXᵢ|=2 broadcast cases and |RX_{K}|=2 multi-bilateral cases with RXₖ, k={3,4}. Each of the TX₁, ∈{4,5} initiates re-sync of the RXₖ, k={3,4} Shared KBs for applications c∈{3,4} with its Shared KBs (if applicable also the update of Local KBs).

Same application: TX₁, ∈{4,5} transmit messages M_{n,i,j}³ of the same application 3 to RXⱼ, i∈{3,4,5}. There are |TXᵢ|=2 broadcast cases and |RXⱼ|=3 conflict cases. Each of the RXⱼ, i∈{3,4,5} selects their pilot and initiate re-sync of their Shared KB for application 3 with all TX₁, ∈{4,5} Shared KBs (if applicable also update of Local KBs). For optimization, the TX₁, ∈{4,5} can also align on their Shared KBs for application 3 certain priority rules.

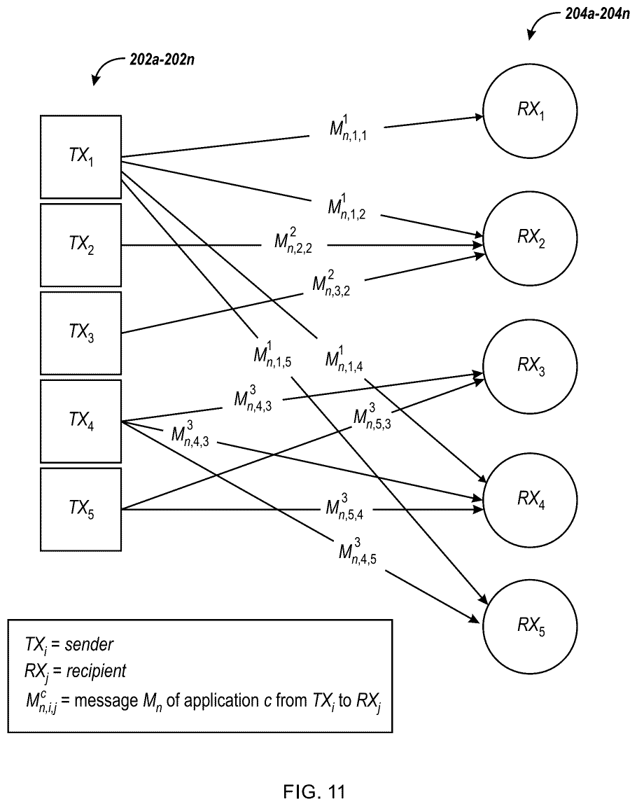

As another example, as shown in FIG. 11, a multiple transmitter devices 202a-n can communicate with a multiple respective receiver device 204a-n. In this example arrangement, there is one broadcast case for TX₁ with RX₁, RX₂, RX₄, and RX₅. Furtherer, there is one multi-bilateral case for TX₁, TX₄, with RX₅. Further, there is one multi-access conflict case for RX₂. Further, there is 1 many-to-many multi-cast conflict case for TX₄, TX₅, and RX₃, RX₄, RX₅.

### Example Techniques for Calculating Semantic Distortion

As described herein, semantic communication can be used to compress data through knowledge-based (KB) inference approaches. For example, in semantic communication, a KB-based message generator (also referred to as a semantic encoder) can compresses data based on semantics and effectiveness. Subsequently the data is passed through the syntactic layers, including the channel encoding and PHY and MAC layers of traditional communication systems.

On the receiver side, the noisy version of the message is passed through the syntactic layers (PHY, MAC), followed by the semantic decoder which interprets the semantic message.

In general, the noise/error/mismatch in semantic communication has at least two sources.
1. During the semantic generation at the transmitter, some part of the data is compressed. At the semantic interpreter, the message is interfered with by local KBs (also referred to as L-KBs), and this mapping is not a priori known mapping. Instead, semantic communication adds an additional element, the “interpretation” of symbols or sequences of symbols (messages). This interpretation map does not have a 1-to-1 mapping of the symbols to messages (as in the case of traditional communication). In such cases, the ambiguity of the semantic noise is a part of semantic communication.
2. As with traditional wireless networking, the noise from a communication channel can induce error on a bit level to the revived messages.

These two sources of errors are intertwined in semantic communication and cannot be decoupled in a straightforward manner. In some implementations, the noise of a channel can be compensated with the semantic decoder capabilities, and in some cases, the ambiguity of semantic communication cannot be resolved even in error-free communication. In such cases, despite traditional networking, in semantic communication, the application layer cannot always be decomposed from syntactic layers and the error at the application layer is not directly related to the networking errors.

Various techniques for identifying and correcting noise/error/mismatch semantic communication (also referred to as semantic distortion) are described herein. distortion are described herein. In at least some implementations, these techniques can include performing “blind” semantic distortion measurements by a device that is a party to the semantic communication, regardless of whether it is the transmitting device or the receiving device (or both).

Further, these techniques can be performed in the context of communicating any type of source data. As an example, source data can include video context, audio content (e.g., voice content, music, sounds, etc.), text content, virtual reality content, mixed reality content, augmented reality content, and/or any other type of content. As another example, source data can include data that is used to perform a particular task (e.g., sensor data, telemetry data, or any other data for controlling the operation of an autonomous vehicle). Although example use cases are described herein, the techniques described herein can be performed in connection with any use case in which data is transmitted from one device to another.

In at least some implementation, these techniques do not require the use of standardized pilot signals between device, and can instead use pilot signals that are generated during a communication session between the device. In some implementations, pilot signals can be used to signal to a device to modify or update one or more knowledge bases (e.g., local knowledge bases, shared knowledge bases, etc.) that are used to perform semantic communication. For example, a pilot signal can signal to a device to synchronize the contents to a knowledge base with another knowledge base, add information to a knowledge base, remove information from a knowledge base, modify information in a knowledge base, etc.

In at least some implementation, these techniques can be performed to calculate semantic error/noise/distortion based on the internal semantic control plane of a device.

In some implementations, these techniques can be performed based on the augmentation of semantic messages and the prediction of the next near future state of the environment or actions of the devices.

These techniques can address various challenges in implementing semantic communication. For example, these techniques can be used to account for noise in L-KBs of the receiver side in the transmitter side without the message passing from the receiver to the transmitter. As another example, these techniques can be used to account for different versions/types of receiver semantic decoder on the receiver side.

Further, these techniques allow a transmitter to determine a predicted measure of semantic distortion error/noise to both (i) proactively prevent (or other reduce) the mismatch and noise in the semantic reconstruction at the receiver (ii) proactively produce an unprecedented situation for task execution among the machines/devices.

In particular, a system for performing semantic communication can include one or more augmentation generators to mimic real signals and replicate them to its noisy, masked, regenerated, restored, and/or modified (e.g., with any generative AI approach) versions.

Further, a system can include one or more semantic encoder mirrors to represent or mimic the behavior of the coding of the other parties in the communication. Further still, a system can include a state augmentation generator for goal/task-oriented communication, and can predict the state of the environment/field of task execution for a specific period of time. Further still, a system can include an action predictor module to predict the actions of the machine/device for a specific period of time.

In some cases, the augmentation generators and/or semantic encoders can be implemented using one or more autoencoders and/or variational auto-encoders. For example, noise and loss function for the variational autoencoder can be used to model the mismatch between transmitters and receivers in semantic communication.

As described with reference to FIG. 2, a device (e.g., a transmitter device and/or a receiver device) has two planes, a data plane and a semantic control plane.

In general, the data plane is responsible for producing the semantic messages from the source data by the semantic encoder and sending it to the syntactic encoder (e.g., using traditional layers of the transmitter, such as L3, MAC, PHY).

The semantic control plane includes a semantic measurement module and a semantic control task module. In general, the semantic measurement module is primarily responsible for calculating the semantic distortion index (SDI). The semantic control task module is responsible for initiating the control task to handle the semantic error and synchronizations among the devices.

In general, a transmitter device generates generate semantically encoded data based on a L-KB, includes data representing the knowledge of the transmitter. At described above, in some implementations, the L-KB can include shared or public knowledge (e.g., data that is shared among multiple users/devices) and/or private knowledge (e.g., data that is kept secret by that device is not shared with other).

Further in at least some implementation, semantic communication can be performed according to a device-oriented approach in which the semantic distortion/noise is measured without any requirements for supervised pilot signals in the semantic error measurement phase. Further, this approach can be performed using a fully distributed SMCE model (e.g., using D-SMCE) without the requirement for sending the public KB among users.

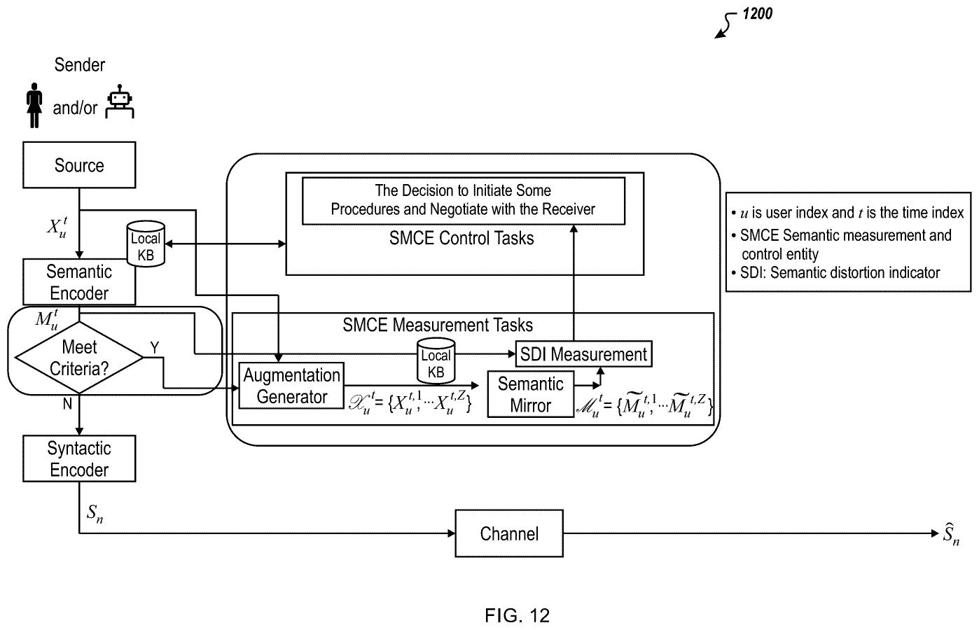

FIG. 12 shows an example system 1200 including a semantic control plane with augmentation. In some implementations, the system 1200 can be a transmitting device.

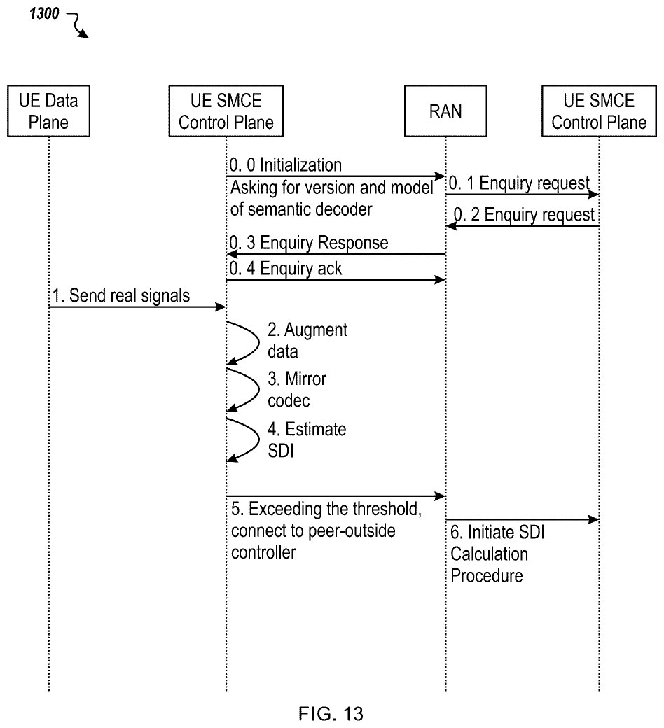

An example process 1300 of operating the system 1200 is shown in FIG. 13.

At Step 0, the SMCE control plane of the system 1200 sends an initiation message to a network (e.g., a radio access network, RAN) (step 0.0), which includes a query for a receiving device for the version and model number of semantic decoder used by the receiving device. The RAN transmits the an enquiry request to the receiving device based on the initialization (step 0.1). In response, the receiving device transmits an enquiry response to the RAN (step 0.2), in which in turn transmits the enquiry response to the transmitting device (step 0.3). The transmitting device transmits an enquiry acknowledgement message in response to receiving the inquiry response (step 0.4).

At Step 1, the transmitting device sends a signal Xᵤ^{t} to the augmentation generator. The augmentation generator “augments” the message into Z replicates of the message Xₙ i.e., [symbol] ᵤ^{t}={ [symbol] ᵤ^{t,1}, . . . [symbol] tᵤ^{t,Z}}.

At Step 2, [symbol] ᵤ^{t} is passed through the semantic mirror module. The semantic mirror module includes an exact function of the semantic encoder, which is a noisy version to show the difference between L-KBs at the transmitter and receivers.

[symbol]

At Step 3, the output of Step 2 is [symbol] ᵤ^{t}={\tilde{M}ᵤ^{t,1}, . . . \tilde{M}ᵤ^{t}}. Subsequently, [symbol] ᵤ^{t} is sent to the SDI measurement module. The federated SDI value of Z replicates of Step 3 are calculated by the SDI measurement module.

At Step 4, the SDI values are sent to SMCE control tasks. The semantic distortion value is calculated depending on the criticality of the application. As an example, a maximum semantic distortion value can be calculated for applications having high criticality, a minimum semantic distortion value can be calculated for applications having low criticality, and an average semantic distortion value can be calculated for applications having medium criticality.

At Step 5, the SMCE control task module determines whether there is a need to initiate the procedure to negotiate with the receiver or other users to improve the quality. The procedure can have different actions, including updating L-KBs, updating the semantic encoder/decoder, and synchronizing the semantic.

In general, the SDI measurement module is responsible for calculating the distance among the messages. In some implementations, the distance between two messages is the actual norm 2 of bitwise competition among two messages, such as:

$${SDI}_{u}^{t} = \frac{1}{Z} {\sum }_{z = 1 , … Z} ‖ {M}_{u}^{t} , {M}_{u}^{t , X} ‖ \\ {SDI}_{u}^{t} = \frac{1}{Z} {\sum }_{z = 1 , … Z} ‖ {X}_{u}^{t} , {X}_{u}^{t , Z} ‖$$

In general, the augmentation generator is a module that produces messages mimicking real messages (e.g., real data) that would be transmitted by the transmitter during semantic communication for privacy and security aspects or for the prediction of SDI.

As an example, the exact message of the transmitter (e.g., source data) Xᵤ^{t} is fed into the augmentation generator, where u and t are indexes of the user at the time t, respectively.

Further, with the mapping [symbol] ᵤ, where u is the index of the transmitter, the augmentation generator produces Z noisy, augmented, or “fake” messages from Xᵤ^{t}, denoted as [symbol] ᵤ^{t}={Xᵤ^{t,1} . . . Xᵤ^{t,z}}. This mapping is shown as [symbol] ᵤ(Xᵤ^{t})→ [symbol] ᵤ^{t}

In general, this mapping can take various forms, depending on the use case. For example, when transmitting images, the mapping can represent images that have been filtered, colored, clipped, rotated, flipped, blurred, modified with additional content, modified to remove content, and/or modified in any other way. As another example, when transmitting text data (e.g., sentences or phrases), the mapping can represent text data in which words have been replaced with synonyms or antonyms, the sentences or phrases have been partitioned, the subject has been replaced with another subject, an objective has been replaced with another objective, an adverb has been replaced with another adverb, and/or modified in any other way. As another example, the mapping can represent partial knowledge about the receiver decoder and its the L-KB, and/or the noise of the channel.

In some implementations, the augmentation generator is fully distributed without the requirement for sharing the public KB among users. Further, an augmentation generator inside of device can communicate internally with the D-SMCE to provide secure and private pilot message for the untrustful RX or in case of non-identified security level. An augmentation generator can be implemented using any generative AI-based component, module, or algorithm, including but not limited to auto encoders and transformers.

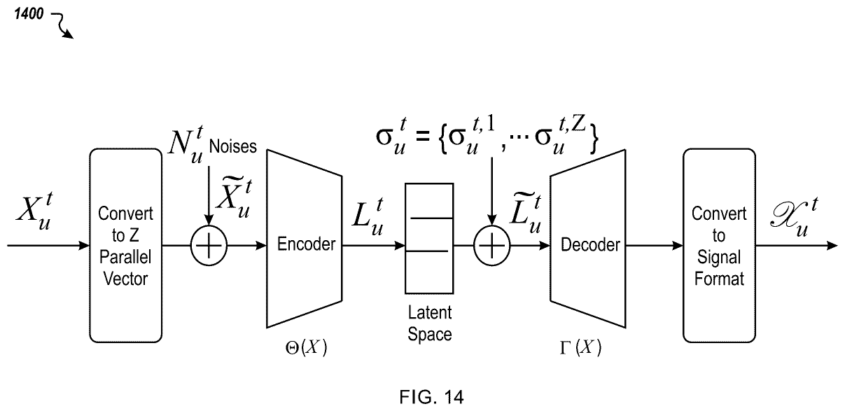

In some cases, the augmentation generator can be implemented using an auto-encoder (e.g., as shown in system 1400 of FIG. 14). Further, an auto-encoder can be used to construct pilot signals from the signals of the transmitters if the semantic signals belong to the latent space.

As an example, an autoencoder can be configured to generate a noisier version of the signal in transmitter side, in accordance with the following steps:

Step 1: Xᵤ^{t} is fed to the vector converter and noise is added at the signal level with the notation Nᵤ^{t} (mimicking channel noise). The output of this step is [symbol] ={ [symbol] , . . . [symbol] , . . . [symbol] }.

Step 2: [symbol] 1-2 is passed to Encoder Θ(X).

Step 3: in the bottleneck, the noise adds to the latent space. This noise can model the L-KB difference between the transmitter and the receiver.

Accordingly, the auto encoder has two components of noise and in two different spaces. These two components of noise can model two different types of uncertainty in the semantic communication (e.g., channel noise and semantic uncertainty due to L-KBs or other mismatches).

In general, the semantic mirror is a semantic encoder residing on the control plane in parallel to the device data plane's semantic encoder in TX. The semantic mirror is responsible to produce semantic messages from based on its own semantic inference and L-KBs (local KB″).

In some implementations, the mapping of the semantic encoder in the data plane is and the control plane encoder map is [symbol] . In such cases, the semantic mirror generates the following messages:

[symbol]

( [symbol] ᵤ^{t})→ [symbol] ᵤ^{t}.

Then, the distance between the constructed semantic message Mᵤ^{t} and Mᵤ^{t} is calculated in the semantic control of the user u. This distance can be calculated as the sum of the norm function of the actual distance among messages:

$${SDI}_{u}^{t} = 1 / Z {\sum }_{z = 1 , … Z} ‖ {M}_{u}^{t} , {M}_{u}^{t , z} ‖ .$$

If [symbol] ᵤ= [symbol] : the semantic message [symbol] ᵤ^{t} shows the error of the semantic decoder of the [symbol] device/transmitter/UE (also referred to as semantic ambiguity).

If [symbol] = [symbol] ᵤ+ [symbol] ₀, where [symbol] ₀ is the Gaussian noise with mean zero and variance σᵤ^{t}, the semantic mirror is semantic plus noise, which can show the uncertainty caused by the semantic decoder in the presence of the channel noise or the partial L-KB of the transmitter.

In some implementation, deviation of the transmitter semantic reconstruction from its own message can be exactly similar to the semantic distortion from the outdated/partial/incomplete L-KBs or the impact of the channel noise.

In some implementations, the semantic mirror can be a version of the receiver semantic encoder/decoder, e.g., [symbol] ᵤ≠ [symbol] . In this case, the SMCE measurement task can predict the mismatch between the version of the transmitter and receiver in semantic coding and decoding.

This mismatch can be caused by the heterogeneous devices, the heterogeneous L-KBs, versions, vendors, and producers.

In general, the semantic mirror can mimic two parts: (i) partial knowledge about the receiver decoder and L-KB and the noise of the channel, and (ii) the term noise has an additional emphasis on the uncertainty and mismatch between the KBs in TX and RX sides. It can also protect the private information through a masking message.

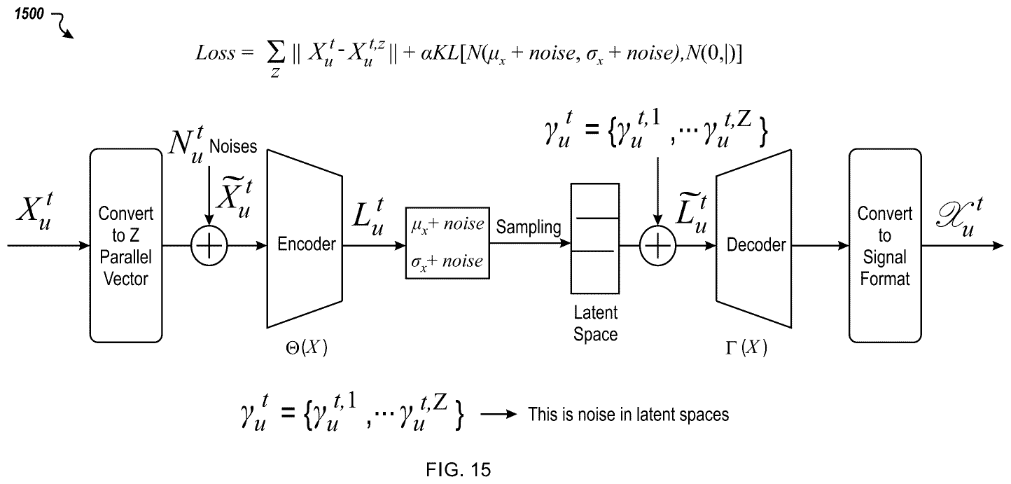

In some impetrations, a variational autoencoder can be used to implement the semantic mirror and/or the augmentation generator (e.g., as shown in system 1500 of FIG. 15). Further, the variational autoencoder can be used to construct both pilot signals and semantic mirror since it can generate content and reconstruct the message simultaneously.

In general, when the SDI is measured at the transmitter and the level of SDI is greater than the specific threshold, SMCE control tasks can be initialized to handle the predicted mismatch among the two parties. Based on the value of the SDI, the semantic control task can initiate different procedures:

Procedure 1: a transmitter can request SDI calculation from the receiver side by sending the pilot signal to the counterpart party.

Procedure 2: a transmitter can request updating the L-KBs between transmitter and receiver

Procedure 3: a transmitter can request switching from semantic to Shannon coding if the bandwidth is available

Procedure 4: the transmitter can request switching from Shannon to semantic, if two parties are synchronized.

Procedure 5: for initializing the control procedure, the threshold can be is as follows:

$${SDI}_{i} = \{ \begin{matrix}\leq {ς}_{i} & Good semantic coding and decoding \\ {ς}_{i} \text{≤≤} {χ}_{i} & Start synchronization and update the L - KB \\ {χ}_{i} \text{≤≤} {ζ}_{i} & \begin{matrix}Start redundancy by sending \\ information coding or saving the data\end{matrix} \\ {Γ}_{i} & Retrain the semantic parameters \\ {γ}_{i} & \begin{matrix}Revisit the task definition , inference function , \\ and update the L - KBS , GKB\end{matrix}\end{matrix}$$

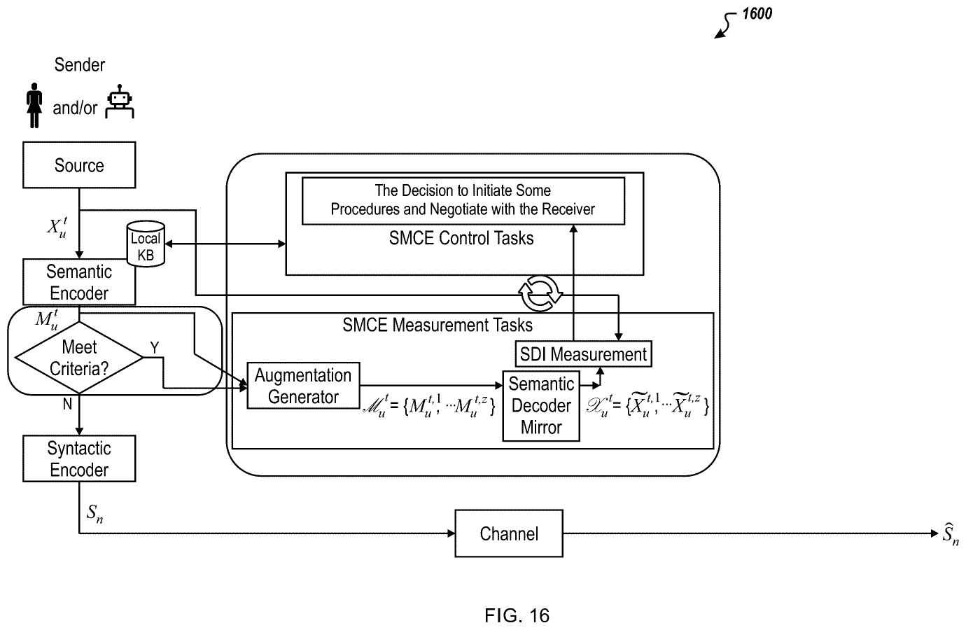

FIG. 16 shows another example system 1600 including a semantic control plane with augmentation. In some implementations, the system 1600 can be a transmitting device. An example operation of the system 1600 is described below.

At Step 1, the message Mᵤ^{t} is sent to the augmentation generator. This module augments the message into Z replicates of the message, e.g., [symbol] ᵤ^{t}={Mᵤ^{t,1}, . . . Mᵤ^{t,Z}}.

At Step 2, [symbol] ᵤ^{t} is passed through the semantic decoder and noise module. This module can include an exact mirror of the semantic decoder at the receiver side or the noisy version of the semantic decoder due to channel noises+uncertain L-KBs. The output of Step 2 is [symbol] ᵤ^{t}={Xᵤ^{t,1}, . . . Xᵤ^{t,Z}}.

At Step 3, the SDI measure is calculated based on the difference between the reconstructed message Xᵤ^{t} and the exact message Xᵤ^{t}. Then, the federated SDI values for replicates of Step 3 are calculated by the SDI measurement module.

At Step 4, the SDI values at sent to SMCE control tasks. The semantic distortion value is calculated depending on the criticality of the application. As an example, a maximum semantic distortion value can be calculated for applications having high criticality, a minimum semantic distortion value can be calculated for applications having low criticality, and an average semantic distortion value can be calculated for applications having medium criticality.

At Step 5, the SMCE control task module determines whether there is a need to initiate the procedure to negotiate with the receiver or other users to improve the quality. The procedure can have different actions, including updating L-KBs, updating the semantic encoder/decoder, and synchronizing the semantic.

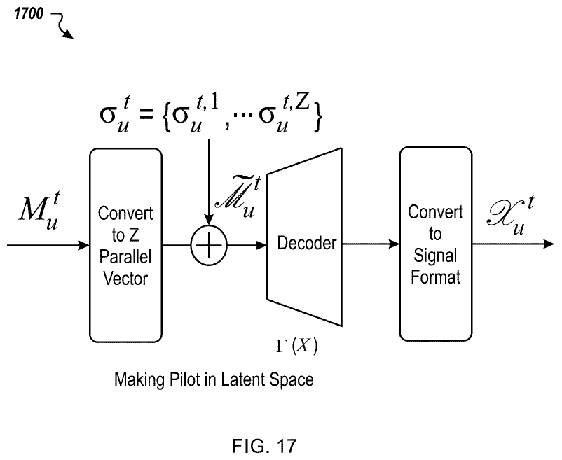

In the system 1600, the augmentation generator also can be implemented using an auto-encoder (e.g., as shown in system 1700 of FIG. 17). Further, a variational autoencoder can be used to construct pilot signals from the transmitter's signals.

As an example, an autoencoder can be configured to perform the following steps:

Step 1: Mᵤ^{t} is fed to the vector converter, and the noise is added at the signal level with the notation Nᵤ^{t} (mimicking channel noise). The output of this step is [symbol] ={ [symbol] ᵤ^{t}+σᵤ^{1,u}, . . . , [symbol] ᵤ^{t}+σᵤ^{Z,u}}.

Step 2: [symbol] is passed through the decode to generate the mimic of the source signal.

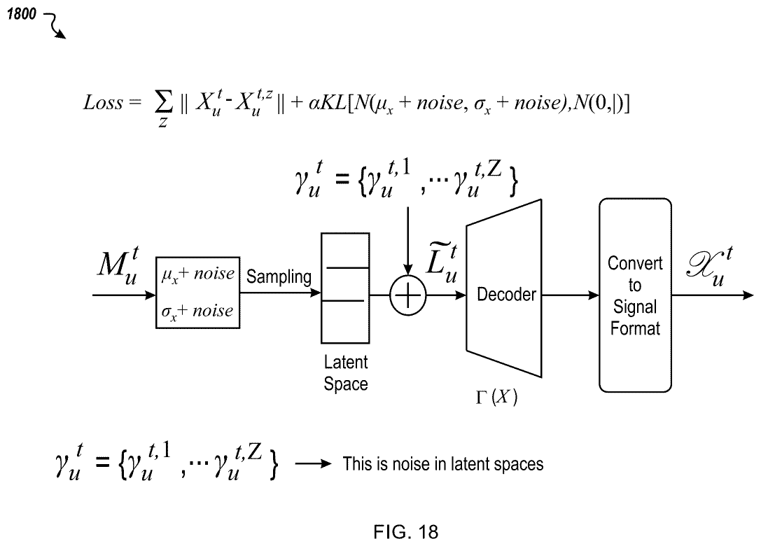

In the system 1600, the semantic mirror and/or augmentation generator also can be implemented using a variational encoder (e.g., as shown in system 1800 of FIG. 18). Further, a variational autoencoder can be used to construct both pilot signals and semantic mirror since it can generate content.

As described above, a wireless communication system can generate semantic data for specific types of use cases. For example, a wireless communication system can generate semantic data specifically to represent data pertaining to the operation of an autonomous vehicle (e.g., sensor data, telemetry data, trajectory data, etc.). As another example, a wireless communication system can generate semantic data for consensus distributed computing and measurement of a particular event (e.g., using one multiple sensors and/or devices). This type of communications may also be referred to as task-orientated communication.

In general, task-oriented communication can pertain to a scenario in which users or devices are involved in taking action in the physical or virtual world. For example, a semantic model for task-oriented communication can depend on the time and location (spatial-temporal feature), and each agent/user can have limited capabilities to percept the environment. Further, agents (e.g., users/devices) can apply semantic coding to communicate with other agents for the most efficient transmission strategies. Semantic messages can be a function of each device's internal states, its perception of the environment, utility function, and critic function.

In some implementations, a device can transmit a semantically coded message when the prediction of the device from its trajectory highly deviates from its observed state of the environment or its estimated trajectory for the next T-time step.

Further, in general, each device can include two planes: a data plane and a control plane. The data plane is responsible for handling the messages among the internal modules, as well as generating the message to share with other devices. The control plane is responsible for predicting the next upcoming states and actions trajectory and keeping track of the deviations of its predictions with the actual observation of the environment and the observed states.

As an example, a set of UE/device for a task, e.g., [symbol] ᵢ={1,2, . . . , [symbol] ₁} can aim to execute one task in the environment during the “age of the task i” (Tᵢ). The devices can collaboratively perform various steps to complete one task. Further, each device machine has access to its internal state, and the device has a partial/limited observation of the full state of the environment depending on its sensing time and coverage. The coverage that each device can sense determines the spatiotemporal feature of the full or partial state of the environment.

In some implementations, the environment can be divided into non-overlapped sub-regions around each device. The sensing time of each device uᵢ as Δᵤ_{ᵢ} and the number of sensing times is Tᵢ/Δᵤ_{ᵢ} The estimated state of the machine uᵢ is

$${\hat{S}}_{{d}_{{u}_{i}}}^{{t}_{{u}_{i}}}$$

where dᵤ_{ᵢ} is the future state or location of the region of the machine uᵢ.

A task i starts as an initial set of states, e.g., Sᵢ⁰ and the goal is to reach the desired state Sᵢ*.

At each time step, the estimated states of all devices are the estimated value of the actual state of the environment, e.g.,

$${\hat{S}}_{i}^{t} = \{ {⋃}_{{u}_{i ∈ {𝒰}_{i}}} {\hat{S}}_{{d}_{{u}_{i}}}^{{t}_{{u}_{i}}} \} .$$

The action of uᵢ time tᵤ_{ᵢ} is

$${a}_{{u}_{i}}^{{t}_{{u}_{i}}}$$

and each action belongs to [symbol] ᵢ={aᵢ¹, aᵢ², aᵢ³, . . . aᵢⁿ}.

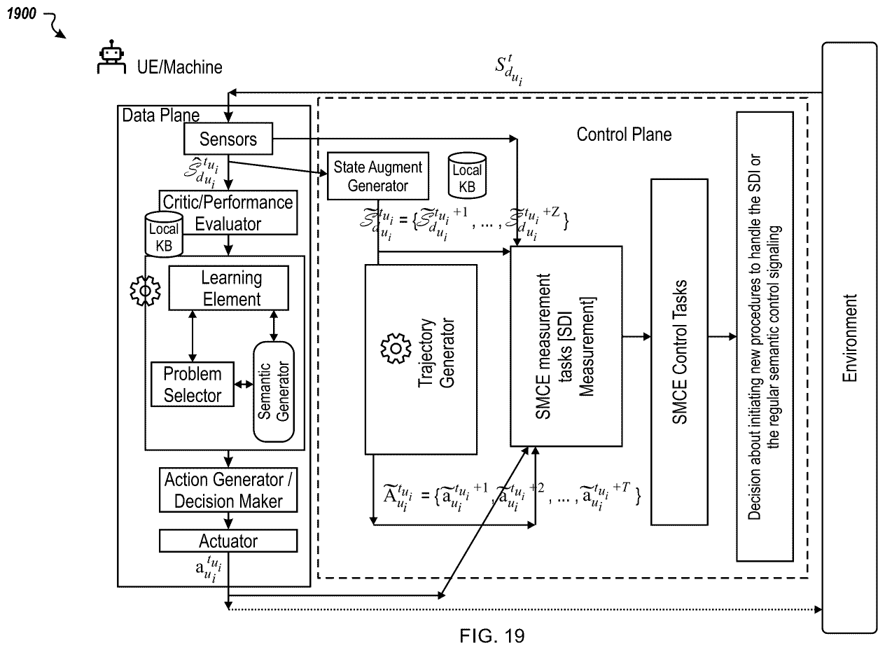

An example system 1900 having a semantic control plane for performing task-oriented communication is shown in FIG. 19. The internal process of the system 1900 in task-oriented communication is represented semantically. In particular, the input of the system 1900 is the perception of the environment (states), and the output of the system 1900 is one action that determines the physical impact of the system 1900 in the real world. In some implementations, the system 1900 can be used to exchange data pertaining to the operation of an autonomous vehicle (e.g., sensor data, telemetry data, trajectory data, etc.) with other devices/system. An example operation of the system 1900 is described below.

At Step 1, at each time step, the received/percept state

$${\hat{S}}_{{d}_{{u}_{i}}}^{{t}_{{u}_{i}}}$$

is augmented to

$${\tilde{𝒮}}_{{d}_{{u}_{i}}}^{{t}_{{u}_{i}}} = \{ {\tilde{𝒮}}_{{d}_{{u}_{i}}}^{{t}_{{u}_{i}} + 1} , {\tilde{𝒮}}_{{d}_{{u}_{i}}}^{{t}_{{u}_{i}} + 2} , … , {\tilde{𝒮}}_{{d}_{{u}_{i}}}^{{t}_{{u}_{i}} + T} \}$$

with a state augment generator. This module augments the message into T replicates of the state of the environment for the upcoming Ttime slots.

At Step 2,

$${\tilde{𝒮}}_{{d}_{{u}_{i}}}^{{t}_{{u}_{i}}}$$

is passed through the trajectory generator, which has its own N−1 experts to generate a set of predicated actions for upcoming time slots based on

$${\tilde{𝒮}}_{{d}_{{u}_{i}}}^{{t}_{{u}_{i}}} .$$

This module predicts the next future action steps based on existing augmented states. This gives the device their trajectories to compare the result of the near future with its prediction.

At Step 3, the output of step 2 is saved in the SMCE measurement task module for the upcoming time slots. The SDI values are sent to SMCE control task modules. Depending on the criticality of the application, the federated SDI value is calculated. This federated value is related to the criticality of the tasks. As an example, a maximum semantic distortion value can be calculated for applications having high criticality, a minimum semantic distortion value can be calculated for applications having low criticality, and an average semantic distortion value can be calculated for applications having medium criticality.

At Step 4, the SMCE control task module determines whether to communicate with other devices to control the deviations or send the regular messages proactively.

In general, the state augmentation generator has two elements, a set of repositories and a prediction module.

The set of repositions include data representing the past perceptions of states and actions of devices, the static features of the environment (e.g., in autonomous driving, the map of the city, road situation, buildings, intersections, etc.), and the dynamic features of the environment (e.g., in autonomous driving, pedestrians, other vehicles, the color of traffic lights, warning alert by other vehicles, etc.).

The prediction module is configured to predict the next states of the environment up to time T based on the above parameters. For example, based on the map of the city, an autonomous vehicle can predict the T steps location of the environment, and augment the prediction with different dynamic parameters. In general, the prediction model can include one or more prediction mechanisms for predicting future states, such as mechanisms that make predictions based on linear regression and/or Kaman filtering (e.g., by adding some noise to the last observed states and the window of W past states and actions of the device).

In general, the trajectory generator is configured to generate T new actions based on the input of state augmentation module. For example, for autonomous vehicles, an action can include causing a vehicle to turn, causing a vehicle to travel at a particular speed, causing a vehicle to increase its speed, causing a vehicle to decrease its speed, causing a vehicle to stop, causing a vehicle to travel in a particular direction, and/or any other operation to control the trajectory or operation of the vehicle.

In some implementations, the trajectory generator can generate new actions based on informed or heuristic algorithms for the semi-static environment. In some implementations, the trajectory generator can generate new actions based on an adversarial Search and game for the competitive environment with Markov-Decision Process (MDP) and reinforcement learning for learning based model. In at least some implementation, the trajectory generated by operate according to a limited time horizon search to predict the near future.

In some implementations, the trajectory generator can be used to add noise to the predicted action (e.g., to represent an estimated trajectory of the actions of users and one or more future unpredicted situations). If the prediction of the user is far from the device's perception of the environment and the action that should be taken, the device can indicate the divergence of the internal learning process of the device from the external world and other device. Further, the semantic/effectiveness control plane can initiate its own procedures (e.g., to update knowledge bases to reduce deviations, etc.).

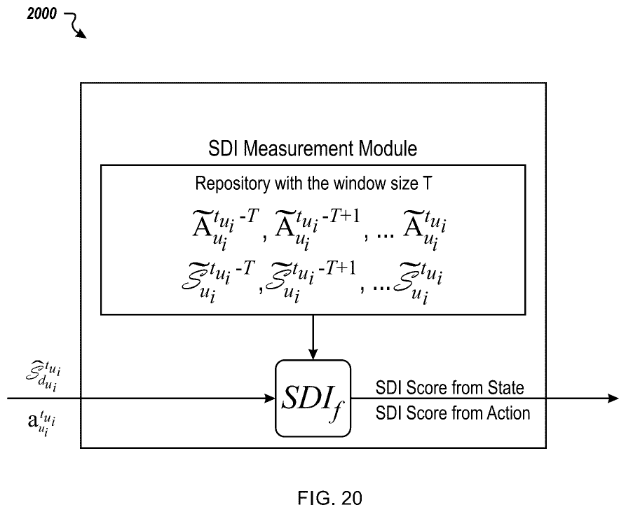

An example SDI measurement module 2000 is shown in FIG. 20. In general, the SDI measurement module has two parts: a repository and a function SDI_{f}.

The repository is responsible for tracking the past T-generated values of the state generation

$$( e . g . , {\tilde{S}}_{{u}_{i}}^{{t}_{{u}_{i}} - T} , {\tilde{S}}_{{u}_{i}}^{{t}_{{u}_{i}} - T + 1} , … . {\tilde{S}}_{{u}_{i}}^{{t}_{{u}_{i}}} )$$

or predicted actions,

$$( e . g . , {\tilde{A}}_{{u}_{i}}^{{t}_{{u}_{i}} - T} , {\tilde{A}}_{{u}_{i}}^{{t}_{{u}_{i}} - T + 1} , … . {\tilde{A}}_{{u}_{i}}^{{t}_{{u}_{i}}} ) .$$

For instance, the repository can determine an average over a moving window.

The function SDI_{f} is configured measure semantic distortion. The actions and the perceptions of the states are compared to these values. The SDI is calculated based on the comparison.

In some implementations, the SDI can be the distance represented by a norm function (e.g., Euclidian distance, Manhattan distance, or ∥·∥∞. Depending on the task requirements, the function can be selected (e.g., for Ultra-Reliable Low Latency Communication, URLLC, use cases), the SDI can be calculate based on the worst case.

In some implementation, the state and/or action can be used for SDI measurement. In some implementations, the steps for these two cases can be similar, except that for one of them, the state for SDI measure can be used for one, and an action can be applied for the other. Further, informed or heuristic algorithms can be used for dynamic features, static environment, a semi-static environment, and/or any combination thereof.

In general, the SMCE control tasks can include determining whether to initiate procedures to handle the SDI or to perform regular semantic control signaling. For example, if the level of SDI is greater than a particular threshold, the system can initiate the control tasks to handle the predicted mismatch between the two parties (e.g., by performing one or more of the control tasks described herein). Further, if the age of the task is passed and the task is not successful or failed, the control plane can facilitate the maintenance of communications among the devices for any request of the application controller.

Although the operations described herein are generally presented in the context of a D-SCME, in practice, some or all of these operations can be performed using a D-SCME, a centralized SCME (C-SMCE), or a combination thereof. As an example, a C-SMCE can provide functionality similar to that of a D-SCME, but can be implemented on a centralized device that is separate and distinct from the transmitting device(s) and receiving device(s) (e.g., a centralized server that mediates semantic communication between them). C-SMCEs are described in greater detail in U.S. Prov. Application. No. 63/541,650, entitled “SEMANTIC COMMUNICATIONS CONTROL AND MANAGEMENT” and filed Sep. 29, 2023, the contents of which are incorporated in this application in their entirety.

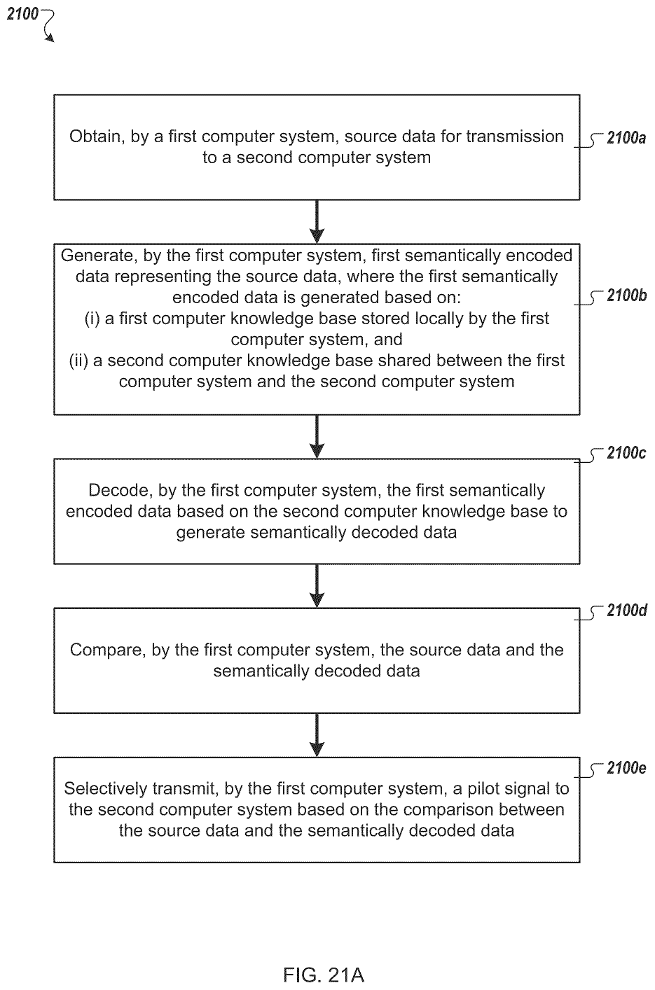

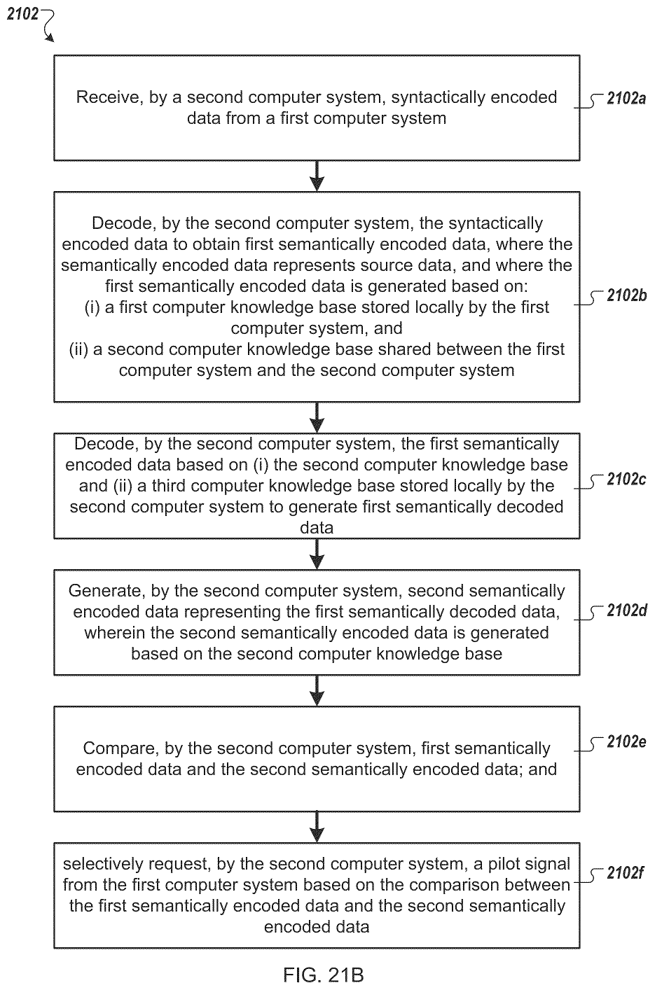

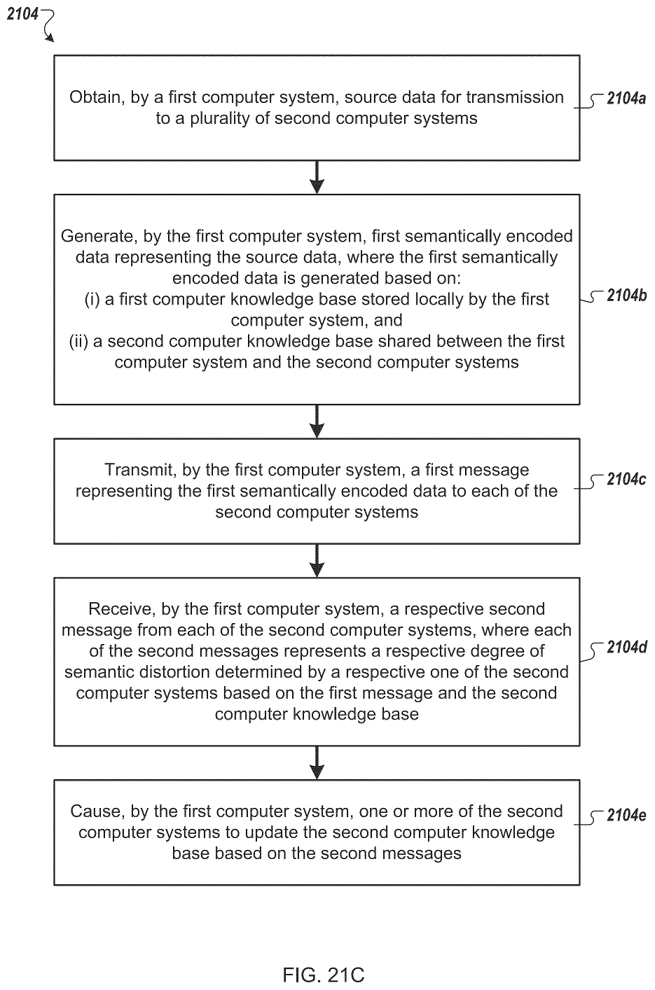

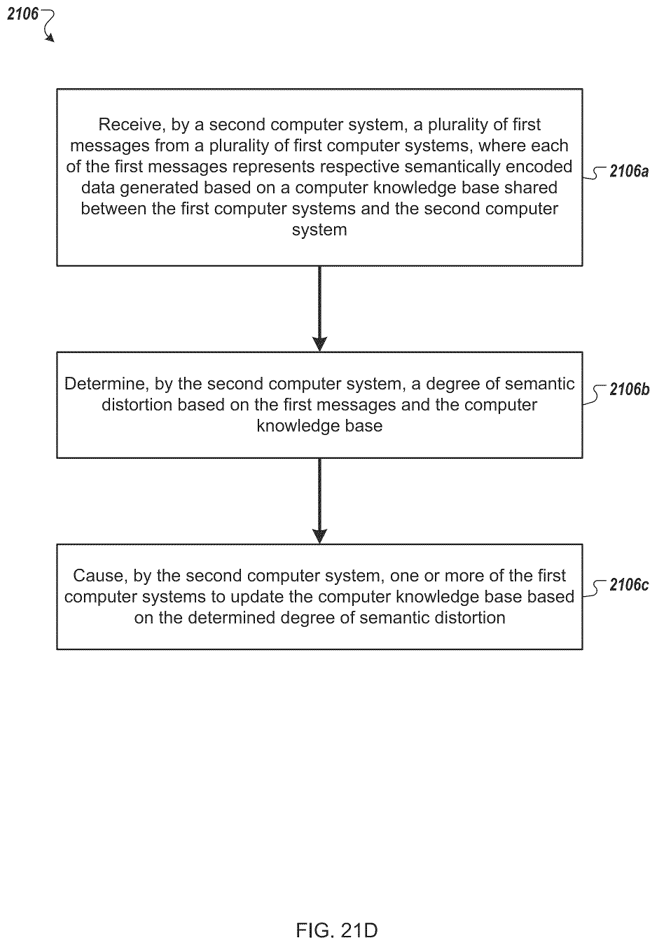

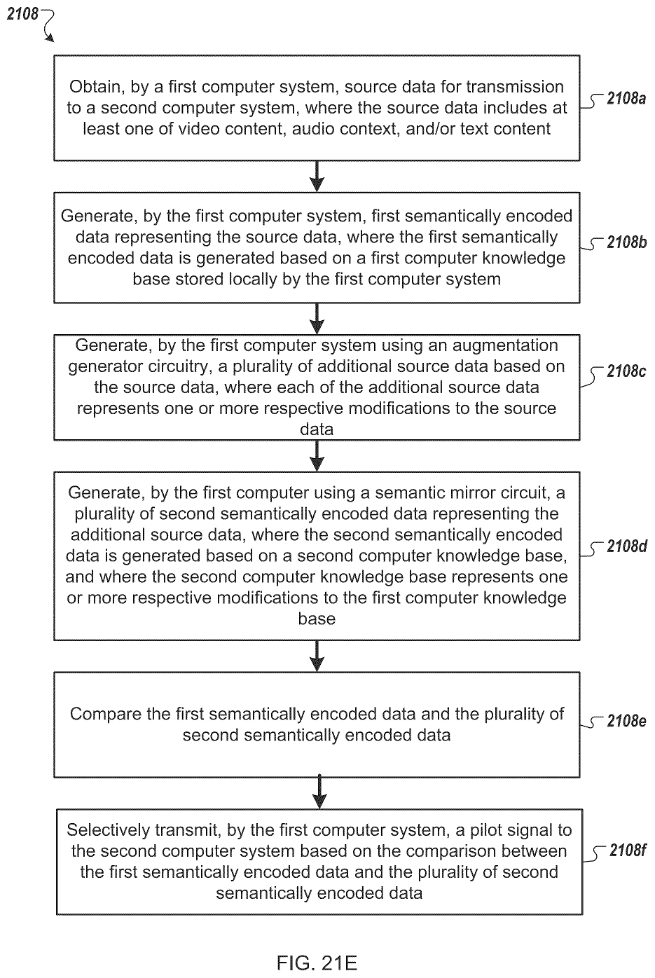

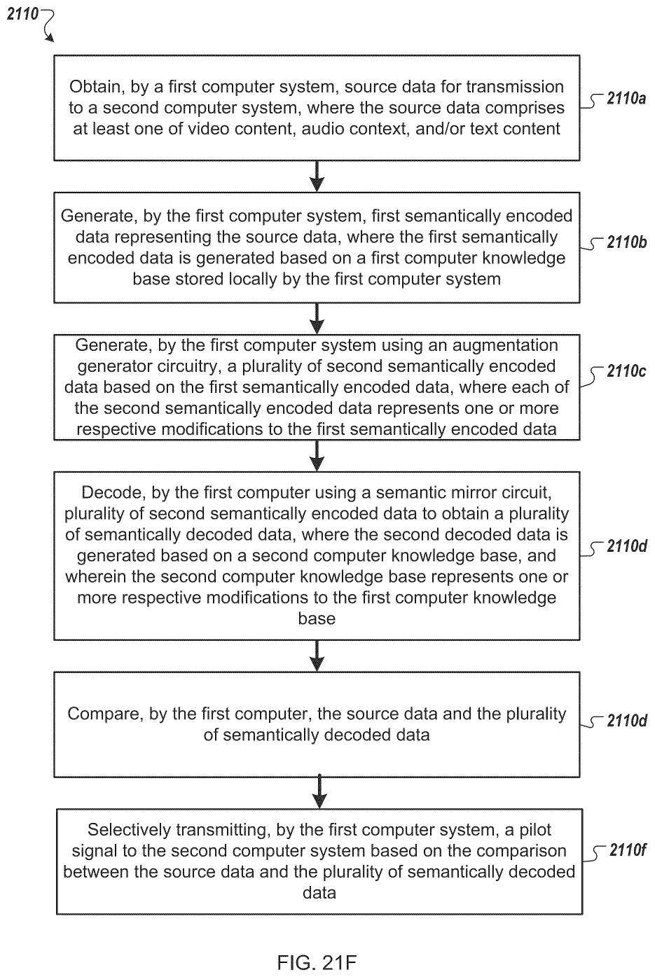

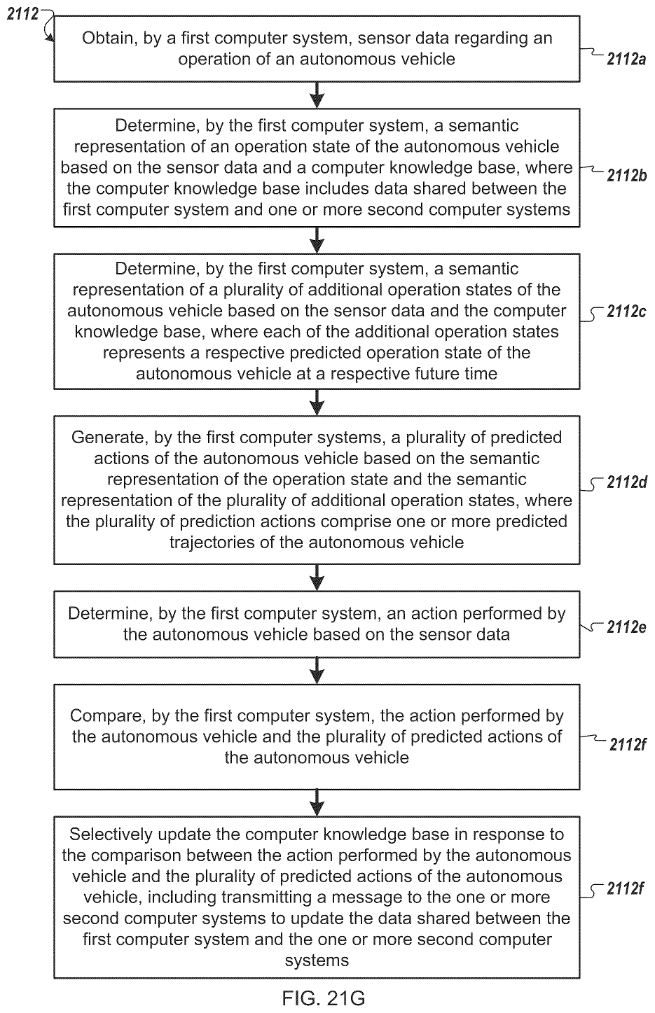

FIG. 21A illustrates a flowchart of an example method 2100, according to some implementations. For clarity of presentation, the description that follows generally describes method 2100 in the context of the other figures in this description. For example, method 2100 can be performed by UE 102 and/or BS 104 of FIG. 1. It will be understood that method 2100 can be performed, for example, by any suitable system, environment, software, hardware, or a combination of systems, environments, software, and hardware, as appropriate. In some implementations, various steps of method 2100 can be run in parallel, in combination, in loops, or in any order.

According to the method 2100, a first computer system obtains source data for transmission to a second computer system (2100a).

The first computer system generates first semantically encoded data representing the source data (2100b). The first semantically encoded data is generated based on (i) a first computer knowledge base stored locally by the first computer system, and (ii) a second computer knowledge base shared between the first computer system and the second computer system.

The first computer system decodes the first semantically encoded data based on the second computer knowledge base to generate semantically decoded data (2100c).

The first computer system compares the source data and the semantically decoded data (2100d).

The first computer system selectively transmits a pilot signal to the second computer system based on the comparison between the source data and the semantically decoded data (2100e).

In some implementations, the pilot signal can represent a modification to the second computer knowledge base.

In some implementations, at least one of the first computer knowledge base or the second computer knowledge base can include data representing a context of the source data.

In some implementations, the pilot signal can be transmitted to the second computer system in response to determining that a difference between the source data and the semantically decoded data is greater than a threshold.

In some implementations, the method can also include (i) generating, by the first computer system, second semantically encoded data representing the semantically decoded data, where the first semantically encoded data is generated based on the first computer knowledge base, (ii) comparing, by the first computer system, the first semantically encoded data and the second semantically encoded data, and (iii) selectively transmitting, by the first computer system, the pilot signal to the second computer system based on the comparison between the first semantically encoded data and the second semantically encoded data.

In some implementations, the pilot signal can be transmitted to the second computer system in response to determining that a difference between the first semantically encoded data and the second semantically encoded data is greater than a threshold.

In some implementations, the method can also include: (i) generating, by the first computer system, syntactically encoded data representing the first semantically encoded data; and (ii) transmitting, by the first computer system, the syntactically encoded data to the second computer system.

In some implementations, the syntactically encoded data can be transmitted to the second computer system via a wireless network.

In some implementations, the first computer system can be a user equipment (UE) of a wireless network.

In some implementations, the first computer system can be a base station of a wireless network.

FIG. 21B illustrates a flowchart of an example method 2102, according to some implementations. For clarity of presentation, the description that follows generally describes method 2102 in the context of the other figures in this description. For example, method 2102 can be performed by UE 102 and/or BS 104 of FIG. 1. It will be understood that method 2102 can be performed, for example, by any suitable system, environment, software, hardware, or a combination of systems, environments, software, and hardware, as appropriate. In some implementations, various steps of method 2102 can be run in parallel, in combination, in loops, or in any order.

According to method 2102, a second computer system receives syntactically encoded data from a first computer system (2102a).

The second computer system decodes the syntactically encoded data to obtain first semantically encoded data (2102b). The semantically encoded data represents source data, where the first semantically encoded data is generated based on: (i) a first computer knowledge base stored locally by the first computer system, and (ii) a second computer knowledge base shared between the first computer system and the second computer system.

The second computer system decodes the first semantically encoded data based on (i) the second computer knowledge base and (ii) a third computer knowledge base stored locally by the second computer system to generate first semantically decoded data (2100c).

The second computer system generates second semantically encoded data representing the first semantically decoded data (2102d). The second semantically encoded data is generated based on the second computer knowledge base.

The second computer system compares the first semantically encoded data and the second semantically encoded data (2102e).

The second computer system selectively requests a pilot signal from the first computer system based on the comparison between the first semantically encoded data and the second semantically encoded data (2102f).

In some implementations, at least one of the first computer knowledge base or the second computer knowledge base can include data representing a context of the source data.

In some implementations, the pilot signal can represent a modification to the second computer knowledge base.

In some implementations, the pilot signal can be requested in response to determining that a difference between the first semantically encoded data and the second semantically encoded data is greater than a threshold.

In some implementations, the method can also include (i) decoding, by the second computer system, the second semantically encoded data based on the second computer knowledge base to generate second semantically decoded data; (ii) comparing, by the second computer system, the first semantically decoded data and the second semantically decoded data; and (iii) selectively requesting, by the second computer system, the pilot signal from the first computer system based on the comparison between the first semantically decoded data and the second semantically decoded data.

In some implementations, the pilot signal can be requested in response to determining that a difference between the first semantically decoded data and the second semantically decoded data is greater than a threshold.

In some implementations, the method can also include determining the source data based on the first semantically decoded data.

In some implementations, the syntactically encoded data can be received from the first computer system via a wireless network.

In some implementations, the second computer system can be a user equipment (UE) of a wireless network.

FIG. 21C illustrates a flowchart of an example method 2104, according to some implementations. For clarity of presentation, the description that follows generally describes method 2104 in the context of the other figures in this description. For example, method 2104 can be performed by UE 102 and/or BS 104 of FIG. 1. It will be understood that method 2104 can be performed, for example, by any suitable system, environment, software, hardware, or a combination of systems, environments, software, and hardware, as appropriate. In some implementations, various steps of method 2104 can be run in parallel, in combination, in loops, or in any order.

According to method 2104, a first computer system obtains source data for transmission to a plurality of second computer systems (2104a).

The first computer system generates first semantically encoded data representing the source data (2104b). The first semantically encoded data is generated based on (i) a first computer knowledge base stored locally by the first computer system, and (ii) a second computer knowledge base shared between the first computer system and the second computer systems.

The first computer system transmits a first message representing the first semantically encoded data to each of the second computer systems (2104c).

The first computer system receives a respective second message from each of the second computer systems (2104d). Each of the second messages represents a respective degree of semantic distortion determined by a respective one of the second computer systems based on the first message and the second computer knowledge base.

The first computer system causes one or more of the second computer systems to update the second computer knowledge base based on the second messages (2104e).

In some implementations, at least one of the first computer knowledge base or the second computer knowledge base can include data representing a context of the source data.

In some implementations, the first message can be transmitted via a wireless network, and the second message can be received via a wireless network.

In some implementations, causing one or more of the second computer systems to update the second computer knowledge base can include causing the one or more second computer systems to update an instance of the second computer knowledge base stored by the one or more second computer systems.

In some implementations, the first computer system and the second computer systems can be are communicatively coupled via a wireless network having at least one of: a tree configuration, a mesh configuration, a clustered configuration, or any combination thereof.

In some implementations, the first computer system can be a user equipment (UE) of a wireless network.

In some implementations, the first computer system can be a base station of a wireless network.

FIG. 21D illustrates a flowchart of an example method 2106, according to some implementations. For clarity of presentation, the description that follows generally describes method 2106 in the context of the other figures in this description. For example, method 2106 can be performed by UE 102 and/or BS 104 of FIG. 1. It will be understood that method 2106 can be performed, for example, by any suitable system, environment, software, hardware, or a combination of systems, environments, software, and hardware, as appropriate. In some implementations, various steps of method 2106 can be run in parallel, in combination, in loops, or in any order.

According to method 2106, a second computer system receives a plurality of first messages from a plurality of first computer systems (2106a). Each of the first messages represents respective semantically encoded data generated based on a computer knowledge base shared between the first computer systems and the second computer system.

The second computer system determines a degree of semantic distortion based on the first messages and the computer knowledge base (2106b).

The second computer system causes one or more of the first computer systems to update the computer knowledge base based on the determined degree of semantic distortion (2106c).

In some implementations, the computer knowledge base can include data representing a context of communications between the second computer system and the plurality of first computer systems.

In some implementations, the plurality of first messages can be received via a wireless network.

In some implementations, causing one or more of the first computer systems to update the computer knowledge base can include causing the one or more first computer systems to update an instance of the computer knowledge base stored by the one or more first computer systems.

In some implementations, the first computer systems and the second computer system can be communicatively coupled via a wireless network having at least one of: a tree configuration, a mesh configuration, a clustered configuration, or any combination thereof.

In some implementations, the first computer system can be a user equipment (UE) of a wireless network.

In some implementations, the first computer system can be a base station of a wireless network.

FIG. 21E illustrates a flowchart of an example method 2108, according to some implementations. For clarity of presentation, the description that follows generally describes method 2108 in the context of the other figures in this description. For example, method 2108 can be performed by UE 102 and/or BS 104 of FIG. 1. It will be understood that method 2108 can be performed, for example, by any suitable system, environment, software, hardware, or a combination of systems, environments, software, and hardware, as appropriate. In some implementations, various steps of method 2108 can be run in parallel, in combination, in loops, or in any order.

According to method 2108, a first computer system obtains source data for transmission to a second computer system (2108a). The source data includes at least one of video content, audio context, and/or text content.

The first computer system generates first semantically encoded data representing the source data (2108b). The first semantically encoded data is generated based on a first computer knowledge base stored locally by the first computer system.

The first computer system generates, using an augmentation generator circuitry, a plurality of additional source data based on the source data (2108c). Each of the additional source data represents one or more respective modifications to the source data.

The first computer generates, using a semantic mirror circuit, a plurality of second semantically encoded data representing the additional source data (2108d). The second semantically encoded data is generated based on a second computer knowledge base. The second computer knowledge base represents one or more respective modifications to the first computer knowledge base.

The first semantically compares the encoded data and the plurality of second semantically encoded data (2108e).

The first computer system selectively transmits a pilot signal to the second computer system based on the comparison between the first semantically encoded data and the plurality of second semantically encoded data (2108f).

In some implementations, at least one of the first computer knowledge base or the second computer knowledge base can include data representing a context of the source data.

In some implementations, the pilot signal can represent a modification to a third computer knowledge base stored by second computer system.

In some implementations, the source data can include video content. Further, the plurality of additional source data can include one or more modifications to a frame rate, a resolution, or a frame of the video content.

In some implementations, the source data can include audio content. Further, the plurality of additional source data can include one or more modifications to a sampling frequency or spectral composition of the audio content.

In some implementations, the source data can include text content. The plurality of additional source data can include one or more modifications to the text content.

In some implementations, the first computer system can be a user equipment (UE) of a wireless network.

In some implementations, the first computer system can be a base station of a wireless network.

FIG. 21F illustrates a flowchart of an example method 2110, according to some implementations. For clarity of presentation, the description that follows generally describes method 2110 in the context of the other figures in this description. For example, method 2110 can be performed by UE 102 and/or BS 104 of FIG. 1. It will be understood that method 2110 can be performed, for example, by any suitable system, environment, software, hardware, or a combination of systems, environments, software, and hardware, as appropriate. In some implementations, various steps of method 2110 can be run in parallel, in combination, in loops, or in any order.

According to method 2110, a first computer system obtains source data for transmission to a second computer system (2110a). The source data includes at least one of video content, audio context, and/or text content;

The first computer system generates first semantically encoded data representing the source data (2110b). The first semantically encoded data is generated based on a first computer knowledge base stored locally by the first computer system.

The first computer system generates, using an augmentation generator circuitry, a plurality of second semantically encoded data based on the first semantically encoded data (2110c). Each of the second semantically encoded data represents one or more respective modifications to the first semantically encoded data.

The first computer system decodes, using a semantic mirror circuit, plurality of second semantically encoded data to obtain a plurality of semantically decoded data (2110d). The second decoded data is generated based on a second computer knowledge base. The second computer knowledge base represents one or more respective modifications to the first computer knowledge base.

The first computer system compares the source data and the plurality of semantically decoded data (2110e).

The first computer system selectively transmits a pilot signal to the second computer system based on the comparison between the source data and the plurality of semantically decoded data (2110f).

In some implementations, at least one of the first computer knowledge base or the second computer knowledge base can include data representing a context of the source data.

In some implementations, the pilot signal can represent a modification to a third computer knowledge base stored by second computer system.

In some implementations, the source data can include video content. Further, the second semantically encoded data can represent one or more modifications to a frame rate, a resolution, or a frame of the video content.

In some implementations, the source data can include audio content. Further, the plurality of second semantically encoded data can represent one or more modifications to a sampling frequency or spectral composition of the audio content.

In some implementations, the source data can include audio content. Further, the plurality of additional source data can include one or more modifications to a sampling rate, bit rate, or spectral composition of the audio content.

In some implementations, the source data can include text content. Further, the plurality of second semantically encoded data can represent one or more modifications to the text content.

In some implementations, the first computer system can be a user equipment (UE) of a wireless network.

In some implementations, the first computer system can be a base station of a wireless network.

FIG. 21G illustrates a flowchart of an example method 2112, according to some implementations. For clarity of presentation, the description that follows generally describes method 2112 in the context of the other figures in this description. For example, method 2112 can be performed by UE 102 and/or BS 104 of FIG. 1. It will be understood that method 2112 can be performed, for example, by any suitable system, environment, software, hardware, or a combination of systems, environments, software, and hardware, as appropriate. In some implementations, various steps of method 2112 can be run in parallel, in combination, in loops, or in any order.

According to method 2112, a first computer system obtains sensor data regarding an operation of an autonomous vehicle (2112a).

The first computer system determines a semantic representation of an operation state of the autonomous vehicle based on the sensor data and a computer knowledge base (2112b). The computer knowledge base includes data shared between the first computer system and one or more second computer systems.

The first computer system determines a semantic representation of a plurality of additional operation states of the autonomous vehicle based on the sensor data and the computer knowledge base (2112c). Each of the additional operation states represents a respective predicted operation state of the autonomous vehicle at a respective future time.

The first computer system generates a plurality of predicted actions of the autonomous vehicle based on the semantic representation of the operation state and the semantic representation of the plurality of additional operation states (2112d). The plurality of prediction actions include one or more predicted trajectories of the autonomous vehicle.

The first computer system determines an action performed by the autonomous vehicle based on the sensor data (2112e).

The first computer system compares the action performed by the autonomous vehicle and the plurality of predicted actions of the autonomous vehicle (2112f).

The computer knowledge base is selectively updated in response to the comparison between the action performed by the autonomous vehicle and the plurality of predicted actions of the autonomous vehicle (2112g). This includes transmitting a message to the one or more second computer systems to update the data shared between the first computer system and the one or more second computer systems.

In some implementations, comparing the action performed by the autonomous vehicle and the plurality of predicted actions of the autonomous vehicle can include determining a degree of semantic distortion between a semantic representation of the action performed by the autonomous vehicle and a semantic representation of the plurality of predicted actions of the autonomous vehicle.

In some implementations, the additional operation states can represent a sequence of predicted operation states of the autonomous vehicle during a sequence of future time slots.

In some implementations, the computer knowledge base can include data representing sensor data previously obtained by the autonomous vehicle and one or more actions previously performed by the autonomous vehicle.

In some implementations, the computer knowledge base can include data representing sensor data previously obtained by one or more additional autonomous vehicles and one or more actions previously performed by the one or more additional autonomous vehicles.

In some implementations, the computer knowledge base can include data representing one or more static features of an environment of the autonomous vehicle.

In some implementations, the data representing one or more static features of an environment of the autonomous vehicle can include data representing at least one of a map of the environment, a road in the environment, or a building in the environment.

In some implementations, the computer knowledge base can include data representing one or more dynamic features of an environment of the autonomous vehicle.

In some implementations, the data representing one or more dynamic features of an environment of the autonomous vehicle can include data representing at least one a vehicle in the environment, a pedestrian in the environment, or a signal state of a traffic signal in the environment.

The example methods shown in FIGS. 21A-21G can be modified or reconfigured to include additional, fewer, or different steps (not shown in FIGS. 21A-21G), which can be performed in the order shown or in a different order.

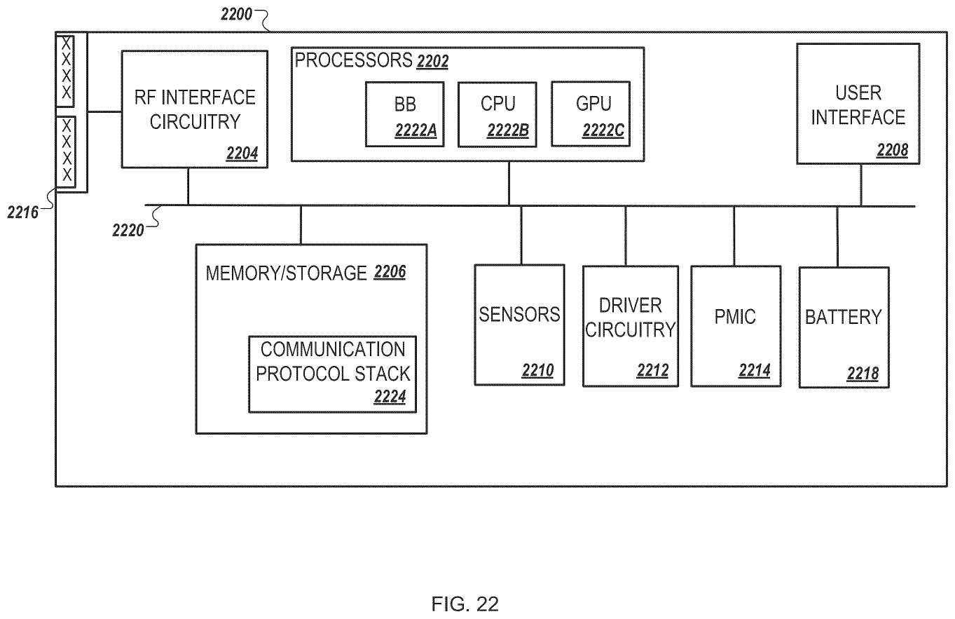

FIG. 22 illustrates an example UE 2200, according to some implementations. The UE 2200 may be similar to and substantially interchangeable with UE 102 of FIG. 1.

The UE 2200 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 2200 may include processors 2202, RF interface circuitry 2204, memory/storage 2206, user interface 2208, sensors 2210, driver circuitry 2212, power management integrated circuit (PMIC) 2214, one or more antenna(s) 2216, and battery 2218. The components of the UE 2200 may be implemented as integrated circuits (ICs), portions thereof, discrete electronic devices, or other modules, logic, hardware, software, firmware, or a combination thereof. The block diagram of FIG. 22 is intended to show a high-level view of some of the components of the UE 2200. However, some of the components shown may be omitted, additional components may be present, and different arrangement of the components shown may occur in other implementations.

The components of the UE 2200 may be coupled with various other components over one or more interconnects 2220, which may represent any type of interface, input/output, bus (local, system, or expansion), transmission line, trace, optical connection, etc. that allows various circuit components (on common or different chips or chipsets) to interact with one another.

The processors 2202 may include processor circuitry such as, for example, baseband processor circuitry (BB) 2222A, central processor unit circuitry (CPU) 2222B, and graphics processor unit circuitry (GPU) 2222C. The processors 2202 may include any type of circuitry or processor circuitry that executes or otherwise operates computer-executable instructions, such as program code, software modules, or functional processes from memory/storage 2206 to cause the UE 2200 to perform operations as described herein.

In some implementations, the baseband processor circuitry 2222A may access a communication protocol stack 2224 in the memory/storage 2206 to communicate over a 3GPP compatible network. In general, the baseband processor circuitry 2222A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 2204. The baseband processor circuitry 2222A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 2206 may include one or more non-transitory, computer-readable media that includes instructions (for example, communication protocol stack 2224) that may be executed by one or more of the processors 2202 to cause the UE 2200 to perform various operations described herein. The memory/storage 2206 include any type of volatile or non-volatile memory that may be distributed throughout the UE 2200. In some implementations, some of the memory/storage 2206 may be located on the processors 2202 themselves (for example, L1 and L2 cache), while other memory/storage 2206 is external to the processors 2202 but accessible thereto via a memory interface. The memory/storage 2206 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2204 may include transceiver circuitry and radio frequency front module (RFEM) that allows the UE 2200 to communicate with other devices over a radio access network. The RF interface circuitry 2204 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 2216 and proceed to filter and amplify (with a low-noise amplifier) the signal. The signal may be provided to a receiver of the transceiver that downconverts the RF signal into a baseband signal that is provided to the baseband processor of the processors 2202.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 2216. In various implementations, the RF interface circuitry 2204 may be configured to transmit/receive signals in a manner compatible with NR access technologies.

The antenna(s) 2216 may include one or more antenna elements to convert electrical signals into radio waves to travel through the air and to convert received radio waves into electrical signals. The antenna elements may be arranged into one or more antenna panels. The antenna(s) 2216 may have antenna panels that are omnidirectional, directional, or a combination thereof to enable beamforming and multiple input, multiple output communications. The antenna(s) 2216 may include microstrip antennas, printed antennas fabricated on the surface of one or more printed circuit boards, patch antennas, phased array antennas, etc. The antenna(s) 2216 may have one or more panels designed for specific frequency bands including bands in FR1 or FR2.

The user interface 2208 includes various input/output (I/O) devices designed to enable user interaction with the UE 2200. The user interface 2208 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 2200.

The sensors 2210 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2212 may include software and hardware elements that operate to control particular devices that are embedded in the UE 2200, attached to the UE 2200, or otherwise communicatively coupled with the UE 2200. The driver circuitry 2212 may include individual drivers allowing other components to interact with or control various input/output (I/O) devices that may be present within, or connected to, the UE 2200. For example, driver circuitry 2212 may include a display driver to control and allow access to a display device, a touchscreen driver to control and allow access to a touchscreen interface, sensor drivers to obtain sensor readings of sensors 2210 and control and allow access to sensors 2210, drivers to obtain actuator positions of electro-mechanic components or control and allow access to the electro-mechanic components, a camera driver to control and allow access to an embedded image capture device, audio drivers to control and allow access to one or more audio devices.

The PMIC 2214 may manage power provided to various components of the UE 2200. In particular, with respect to the processors 2202, the PMIC 2214 may control power-source selection, voltage scaling, battery charging, or DC-to-DC conversion.

In some implementations, the PMIC 2214 may control, or otherwise be part of, various power saving mechanisms of the UE 2200. A battery 2218 may power the UE 2200, although in some examples the UE 2200 may be mounted deployed in a fixed location, and may have a power supply coupled to an electrical grid. The battery 2218 may be a lithium ion battery, a metal-air battery, such as a zinc-air battery, an aluminum-air battery, a lithium-air battery, and the like. In some implementations, such as in vehicle-based applications, the battery 2218 may be a typical lead-acid automotive battery.

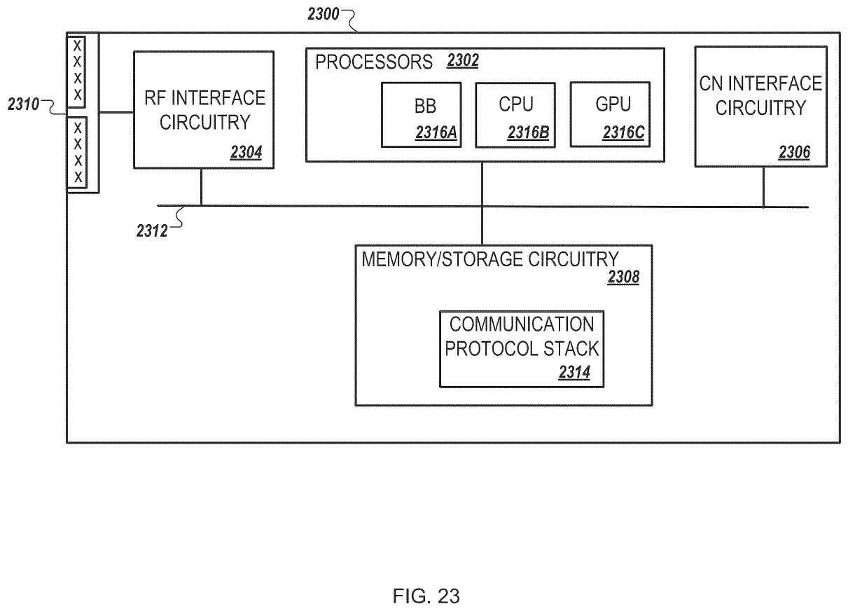

FIG. 23 illustrates an example access node 2300 (e.g., a base station or gNB), according to some implementations. The access node 2300 may be similar to and substantially interchangeable with base station 104. The access node 2300 may include processors 2302, RF interface circuitry 2304, core network (CN) interface circuitry 2306, memory/storage circuitry 2308, and one or more antenna(s) 2310.

The components of the access node 2300 may be coupled with various other components over one or more interconnects 2312. The processors 2302, RF interface circuitry 2304, memory/storage circuitry 2308 (including communication protocol stack 2314), antenna(s) 2310, and interconnects 2312 may be similar to like-named elements shown and described with respect to FIG. 22. For example, the processors 2302 may include processor circuitry such as, for example, baseband processor circuitry (BB) 2316A, central processor unit circuitry (CPU) 2316B, and graphics processor unit circuitry (GPU) 2316C.

The CN interface circuitry 2306 may provide connectivity to a core network, for example, a 5th Generation Core network (5GC) using a 5GC-compatible network interface protocol such as carrier Ethernet protocols, or some other suitable protocol. Network connectivity may be provided to/from the access node 2300 via a fiber optic or wireless backhaul. The CN interface circuitry 2306 may include one or more dedicated processors or FPGAs to communicate using one or more of the aforementioned protocols. In some implementations, the CN interface circuitry 2306 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 2300 that operates in an NR or 5G system (for example, a gNB), and the term “E-UTRAN node” or the like may refer to an access node 2300 that operates in an LTE or 4G system (e.g., an eNB). According to various implementations, the access node 2300 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 2300 may be implemented as one or more software entities running on server computers as part of a virtual network, which may be referred to as a CRAN and/or a virtual baseband unit pool (vBBUP). In V2X scenarios, the access node 2300 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example A1 includes a method. The method includes: obtaining, by a first computer system, source data for transmission to a second computer system; generating, by the first computer system, first semantically encoded data representing the source data, where the first semantically encoded data is generated based on: a first computer knowledge base stored locally by the first computer system, and a second computer knowledge base shared between the first computer system and the second computer system; decoding, by the first computer system, the first semantically encoded data based on the second computer knowledge base to generate semantically decoded data; comparing, by the first computer system, the source data and the semantically decoded data; and selectively transmitting, by the first computer system, a pilot signal to the second computer system based on the comparison between the source data and the semantically decoded data.

Example A2 includes the method of Example A1. Further, the pilot signal represents a modification to the second computer knowledge base.

Example A3 includes the method of Examples A1 or A2. Further, at least one of the first computer knowledge base or the second computer knowledge base includes data representing a context of the source data.

Example A4 includes the method of any of Examples A1-A3. Further, the pilot signal is transmitted to the second computer system in response to determining that a difference between the source data and the semantically decoded data is greater than a threshold.

Example A5 includes the method of any of Examples A1-A4. Further, the method includes: generating, by the first computer system, second semantically encoded data representing the semantically decoded data, where the first semantically encoded data is generated based on the first computer knowledge base; comparing, by the first computer system, the first semantically encoded data and the second semantically encoded data; selectively transmitting, by the first computer system, the pilot signal to the second computer system based on the comparison between the first semantically encoded data and the second semantically encoded data.

Example A6 includes the method of any of Examples A1-A5. Further, the pilot signal is transmitted to the second computer system in response to determining that a difference between the first semantically encoded data and the second semantically encoded data is greater than a threshold.

Example A7 includes the method of any of Examples A1-A6. Further, the method includes generating, by the first computer system, syntactically encoded data representing the first semantically encoded data; and transmitting, by the first computer system, the syntactically encoded data to the second computer system.

Example A8 includes the method of any of Examples A1-A7. Further, the syntactically encoded data is transmitted to the second computer system via a wireless network.

Example A9 includes the method of any of Examples A1-A8. Further, the first computer system is a user equipment (UE) of a wireless network.

Example A10 includes the method of any of Examples A1-A9. Further, the first computer system is a base station of a wireless network.

Example B1 includes a method. The method includes: receiving, by a second computer system, syntactically encoded data from a first computer system; decoding, by the second computer system, the syntactically encoded data to obtain first semantically encoded data, where the semantically encoded data represents source data, where the first semantically encoded data is generated based on: a first computer knowledge base stored locally by the first computer system, and a second computer knowledge base shared between the first computer system and the second computer system; decoding, by the second computer system, the first semantically encoded data based on (i) the second computer knowledge base and (ii) a third computer knowledge base stored locally by the second computer system to generate first semantically decoded data; generating, by the second computer system, second semantically encoded data representing the first semantically decoded data, where the second semantically encoded data is generated based on the second computer knowledge base; comparing, by the second computer system, first semantically encoded data and the second semantically encoded data; and selectively requesting, by the second computer system, a pilot signal from the first computer system based on the comparison between the first semantically encoded data and the second semantically encoded data.

Example B2 includes the method of Example B1. Further, at least one of the first computer knowledge base or the second computer knowledge base includes data representing a context of the source data.

Example B3 includes the method of Examples B1 or B2. Further, the pilot signal represents a modification to the second computer knowledge base.

Example B4 includes the method of any of Examples B1-B3. Further, the pilot signal is requested in response to determining that a difference between the first semantically encoded data and the second semantically encoded data is greater than a threshold.

Example B5 includes the method of any of Examples B1-B4. Further, the method includes: decoding, by the second computer system, the second semantically encoded data based on the second computer knowledge base to generate second semantically decoded data; comparing, by the second computer system, the first semantically decoded data and the second semantically decoded data; selectively requesting, by the second computer system, the pilot signal from the first computer system based on the comparison between the first semantically decoded data and the second semantically decoded data.

Example B6 includes the method of any of Examples B1-B5. Further, the pilot signal is requested in response to determining that a difference between the first semantically decoded data and the second semantically decoded data is greater than a threshold.

Example B7 includes the method of any of Examples B1-B6. Further, the method includes determining the source data based on the first semantically decoded data.

Example B8 includes the method of any of Examples B1-B7. Further, the syntactically encoded data is received from the first computer system via a wireless network.

Example B9 includes the method of any of Examples B1-B8. Further, the second computer system is a user equipment (UE) of a wireless network.

Example B10 includes the method of any of Examples B1-B9. Further, the second computer system is a base station of a wireless network.

Example C1 includes a method. The method includes: obtaining, by a first computer system, source data for transmission to a plurality of second computer systems; generating, by the first computer system, first semantically encoded data representing the source data, where the first semantically encoded data is generated based on: a first computer knowledge base stored locally by the first computer system, and a second computer knowledge base shared between the first computer system and the second computer systems; transmitting, by the first computer system, a first message representing the first semantically encoded data to each of the second computer systems; receiving, by the first computer system, a respective second message from each of the second computer systems, where each of the second messages represents a respective degree of semantic distortion determined by a respective one of the second computer systems based on the first message and the second computer knowledge base; and causing, by the first computer system, one or more of the second computer systems to update the second computer knowledge base based on the second messages.

Example C2 includes the method of Example C1. Further, at least one of the first computer knowledge base or the second computer knowledge base includes data representing a context of the source data.

Example C3 includes the method of Examples C1 or C2. Further, the first message is transmitted via a wireless network, and the second message can be received via a wireless network.

Example C4 includes the method of any of Examples C1-C3. Further, the method includes causing one or more of the second computer systems to update the second computer knowledge base can include causing the one or more second computer systems to update an instance of the second computer knowledge base stored by the one or more second computer systems.

Example C5 includes the method of any of Examples C1-C4. Further, the first computer system and the second computer systems are communicatively coupled via a wireless network having at least one of: a tree configuration, a mesh configuration, a clustered configuration, or any combination thereof.

Example C6 includes the method of any of Examples C1-C5. Further, the first computer system is a user equipment (UE) of a wireless network.

Example C7 includes the method of any of Examples C1-C6. Further, the first computer system is a base station of a wireless network.

Example D1 includes a method. The method includes: receiving, by a second computer system, a plurality of first messages from a plurality of first computer systems, where each of the first messages represents respective semantically encoded data generated based on a computer knowledge base shared between the first computer systems and the second computer system; determining, by the second computer system, a degree of semantic distortion based on the first messages and the computer knowledge base; and causing, by the second computer system, one or more of the first computer systems to update the computer knowledge base based on the determined degree of semantic distortion.

Example D2 includes the method of Example D1. Further, the computer knowledge base includes data representing a context of communications between the second computer system and the plurality of first computer systems.

Example D3 includes the method of Examples D1 or D2. Further, the plurality of first messages are received via a wireless network.

Example D4 includes the method of any of Examples D1-D3. Further, the method includes causing one or more of the first computer systems to update the computer knowledge base can include causing the one or more first computer systems to update an instance of the computer knowledge base stored by the one or more first computer systems.

Example D5 includes the method of any of Examples D1-D4. Further, the first computer systems and the second computer system are communicatively coupled via a wireless network having at least one of: a tree configuration, a mesh configuration, a clustered configuration, or any combination thereof.

Example D6 includes the method of any of Examples D1-D5. Further, the first computer system is a user equipment (UE) of a wireless network.

Example D7 includes the method of any of Examples D1-D6. Further, the first computer system is a base station of a wireless network.

Example E1 includes a method. The method includes: obtaining, by a first computer system, source data for transmission to a second computer system, where the source data includes at least one of video content, audio context, and/or text content; generating, by the first computer system, first semantically encoded data representing the source data, where the first semantically encoded data is generated based on a first computer knowledge base stored locally by the first computer system; generating, by the first computer system using an augmentation generator circuitry, a plurality of additional source data based on the source data, where each of the additional source data represents one or more respective modifications to the source data; generating, by the first computer using a semantic mirror circuit, a plurality of second semantically encoded data representing the additional source data, where the second semantically encoded data is generated based on a second computer knowledge base, and where the second computer knowledge base represents one or more respective modifications to the first computer knowledge base; comparing the first semantically encoded data and the plurality of second semantically encoded data; and selectively transmitting, by the first computer system, a pilot signal to the second computer system based on the comparison between the first semantically encoded data and the plurality of second semantically encoded data.

Example E2 includes the method of Example E1. Further, at least one of the first computer knowledge base or the second computer knowledge base includes data representing a context of the source data.

Example E3 includes the method of Examples E1 or E2. Further, the pilot signal represents a modification to a third computer knowledge base stored by second computer system.

Example E4 includes the method of any of Examples E1-E3. Further,

In some implementations, the source data can include video content. Further, the plurality of additional source data can include one or more modifications to a frame rate, a resolution, or a frame of the video content.

Example E4 includes the method of any of Examples E1-E3. Further, the source data includes audio content. The plurality of additional source data includes one or more modifications to a sampling frequency or spectral composition of the audio content.

Example E5 includes the method of any of Examples E1-E4. Further, the source data includes text content. The plurality of additional source data includes one or more modifications to the text content.

Example E6 includes the method of any of Examples E1-E5. Further, the first computer system is a user equipment (UE) of a wireless network.

Example E7 includes the method of any of Examples E1-E6. Further, the first computer system is a base station of a wireless network.\

Example F1 includes a method. The method includes: obtaining, by a first computer system, source data for transmission to a second computer system, where the source data includes at least one of video content, audio context, and/or text content; generating, by the first computer system, first semantically encoded data representing the source data, where the first semantically encoded data is generated based on a first computer knowledge base stored locally by the first computer system; generating, by the first computer system using an augmentation generator circuitry, a plurality of second semantically encoded data based on the first semantically encoded data, where each of the second semantically encoded data represents one or more respective modifications to the first semantically encoded data; decoding, by the first computer using a semantic mirror circuit, plurality of second semantically encoded data to obtain a plurality of semantically decoded data, where the second decoded data is generated based on a second computer knowledge base, and where the second computer knowledge base represents one or more respective modifications to the first computer knowledge base; comparing, by the first computer system, the source data and the plurality of semantically decoded data; and selectively transmitting, by the first computer system, a pilot signal to the second computer system based on the comparison between the source data and the plurality of semantically decoded data.

Example F2 includes the method of Example F1. Further, at least one of the first computer knowledge base or the second computer knowledge base includes data representing a context of the source data.

Example F3 includes the method of Examples F1 or F2. Further, the pilot signal represents a modification to a third computer knowledge base stored by second computer system.

Example F4 includes the method of any of Examples F1-F3. Further,

In some implementations, the source data can include video content. The second semantically encoded data can represent one or more modifications to a frame rate, a resolution, or a frame of the video content.

Example F4 includes the method of any of Examples F1-F3. Further, the plurality of second semantically encoded data represents one or more modifications to a sampling frequency or spectral composition of the audio content.

Example F5 includes the method of any of Examples F1-F4. Further, the source data includes audio content. The plurality of additional source data includes one or more modifications to a sampling rate, bit rate, or spectral composition of the audio content.

Example F6 includes the method of any of Examples F1-F5. Further, the source data includes text content. The plurality of second semantically encoded data represent one or more modifications to the text content.

Example F7 includes the method of any of Examples F1-F6. Further, the first computer system is a user equipment (UE) of a wireless network.

Example F8 includes the method of any of Examples F1-F7. Further, the first computer system is a base station of a wireless network.

Example G1 includes a method. The method includes: obtaining, by a first computer system, sensor data regarding an operation of an autonomous vehicle; determining, by the first computer system, a semantic representation of an operation state of the autonomous vehicle based on the sensor data and a computer knowledge base, where the computer knowledge base includes data shared between the first computer system and one or more second computer systems; determining, by the first computer system, a semantic representation of a plurality of additional operation states of the autonomous vehicle based on the sensor data and the computer knowledge base, where each of the additional operation states represents a respective predicted operation state of the autonomous vehicle at a respective future time; generating, by the first computer systems, a plurality of predicted actions of the autonomous vehicle based on the semantic representation of the operation state and the semantic representation of the plurality of additional operation states, where the plurality of prediction actions include one or more predicted trajectories of the autonomous vehicle; determining, by the first computer system, an action performed by the autonomous vehicle based on the sensor data; comparing, by the first computer system, the action performed by the autonomous vehicle and the plurality of predicted actions of the autonomous vehicle; and selectively updating the computer knowledge base in response to the comparison between the action performed by the autonomous vehicle and the plurality of predicted actions of the autonomous vehicle, including transmitting a message to the one or more second computer systems to update the data shared between the first computer system and the one or more second computer systems.

Example G2 includes the method of G1. Further, the method includes comparing the action performed by the autonomous vehicle and the plurality of predicted actions of the autonomous vehicle can include determining a degree of semantic distortion between a semantic representation of the action performed by the autonomous vehicle and a semantic representation of the plurality of predicted actions of the autonomous vehicle.

Example G3 includes the method of Examples G1 or G2. Further, the additional operation states represent a sequence of predicted operation states of the autonomous vehicle during a sequence of future time slots.

Example G4 includes the method of any of Examples G1-G3. Further, the computer knowledge base includes data representing sensor data previously obtained by the autonomous vehicle and one or more actions previously performed by the autonomous vehicle.

Example G5 includes the method of any of Examples G1-G4. Further, the computer knowledge base includes data representing sensor data previously obtained by one or more additional autonomous vehicles and one or more actions previously performed by the one or more additional autonomous vehicles.

Example G6 includes the method of any of Examples G1-G5. Further, the computer knowledge base includes data representing one or more static features of an environment of the autonomous vehicle.

Example G7 includes the method of any of Examples G1-G6. Further, the data represents one or more static features of an environment of the autonomous vehicle can include data representing at least one of a map of the environment, a road in the environment, or a building in the environment.

Example G8 includes the method of any of Examples G1-G7. Further, the computer knowledge base includes data representing one or more dynamic features of an environment of the autonomous vehicle.

Example G9 includes the method of any of Examples G1-G8. Further, the data representing one or more dynamic features of an environment of the autonomous vehicle includes data representing at least one a vehicle in the environment, a pedestrian in the environment, or a signal state of a traffic signal in the environment.

Example H1 includes one or more non-transitory computer-readable media including instructions to cause an electronic device, upon execution of the instructions by one or more processors of the electronic device, to perform one or more elements of a method described in or related to any of the examples herein, or any other method or process described herein.

Example I1 includes an apparatus including logic, modules, or circuitry to perform one or more elements of a method described in or related to any of the examples herein, or any other method or process described herein.

Example J1 includes a method, technique, or process as described in or related to any of the examples herein, or portions or parts thereof.

Example K1 includes an apparatus including: one or more processors and one or more computer-readable media including instructions that, when executed by the one or more processors, cause the one or more processors to perform the method, techniques, or process as described in or related to any of the examples herein, or portions thereof.

Example L1 includes a signal as described in or related to any of the examples herein, or portions or parts thereof.

Example M1 incudes a datagram, information element, packet, frame, segment, PDU, or message as described in or related to any of the examples herein, or portions or parts thereof, or otherwise described in the present disclosure.

Example N1 includes include a signal encoded with data as described in or related to any of the examples herein, or portions or parts thereof, or otherwise described in the present disclosure.

Example O1 incudes a signal encoded with a datagram, IE, packet, frame, segment, PDU, or message as described in or related to any of the examples herein, or portions or parts thereof, or otherwise described in the present disclosure.

Example P1 includes an electromagnetic signal carrying computer-readable instructions, wherein execution of the computer-readable instructions by one or more processors is to cause the one or more processors to perform the method, techniques, or process as described in or related to any of the examples herein, or portions thereof.

Example Q1 includes a computer program including instructions, wherein execution of the program by a processing element is to cause the processing element to carry out the method, techniques, or process as described in or related to any of the examples herein, or portions thereof. The operations or actions performed by the instructions executed by the processing element can include the methods of any one of the examples herein.

Example R1 includes a signal in a wireless network as shown and described herein.

Example S1 includes a method of communicating in a wireless network as shown and described herein.

Example T1 includes a system for providing wireless communication as shown and described herein. The operations or actions performed by the system can include the methods of any one of the examples herein.

Example U1 includes a device for providing wireless communication as shown and described herein. The operations or actions performed by the device can include the methods of any one of the examples herein.

The previously-described examples are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The operations or actions performed either by the system or by the instructions executed by data processing apparatus can include the methods of any one of the examples herein.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of the examples herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

1. A method comprising:
obtaining, by a first computer system, source data for transmission to a second computer system;
generating, by the first computer system, first semantically encoded data representing the source data, wherein the first semantically encoded data is generated based on:
a first computer knowledge base stored locally by the first computer system, and
a second computer knowledge base shared between the first computer system and the second computer system;
decoding, by the first computer system, the first semantically encoded data based on the second computer knowledge base to generate semantically decoded data;
comparing, by the first computer system, the source data and the semantically decoded data; and
selectively transmitting, by the first computer system, a pilot signal to the second computer system based on the comparison between the source data and the semantically decoded data.

2. The method of claim 1, wherein the pilot signal represents a modification to the second computer knowledge base.

3. The method of claim 1, wherein at least one of the first computer knowledge base or the second computer knowledge base comprises data representing a context of the source data.

4. The method of claim 1, wherein the pilot signal is transmitted to the second computer system in response to determining that a difference between the source data and the semantically decoded data is greater than a threshold.

5. The method of claim 1, further comprising:
generating, by the first computer system, second semantically encoded data representing the semantically decoded data, wherein the first semantically encoded data is generated based on the first computer knowledge base;
comparing, by the first computer system, the first semantically encoded data and the second semantically encoded data;
selectively transmitting, by the first computer system, the pilot signal to the second computer system based on the comparison between the first semantically encoded data and the second semantically encoded data.

6. The method of claim 5, wherein the pilot signal is transmitted to the second computer system in response to determining that a difference between the first semantically encoded data and the second semantically encoded data is greater than a threshold.

7. The method of claim 1, further comprising:
generating, by the first computer system, syntactically encoded data representing the first semantically encoded data; and
transmitting, by the first computer system, the syntactically encoded data to the second computer system.

8. The method of claim 7, wherein the syntactically encoded data is transmitted to the second computer system via a wireless network.

9. The method of claim 1, wherein the first computer system is a user equipment (UE) of a wireless network.

10. The method of claim 1, wherein the first computer system is a base station of a wireless network.

11-74. (canceled)

75. An apparatus comprising one or more processors configured to perform operations comprising:
obtaining source data for transmission to a computer system;
generating first semantically encoded data representing the source data, wherein the first semantically encoded data is generated based on:
a first computer knowledge base stored locally by the apparatus, and
a second computer knowledge base shared between the apparatus and the computer system;
decoding the first semantically encoded data based on the second computer knowledge base to generate semantically decoded data;
comparing the source data and the semantically decoded data; and
selectively transmitting a pilot signal to the computer system based on the comparison between the source data and the semantically decoded data.

76. The apparatus of claim 75, wherein the pilot signal represents a modification to the second computer knowledge base.

77. The apparatus of claim 75, wherein at least one of the first computer knowledge base or the second computer knowledge base comprises data representing a context of the source data.

78. The apparatus of claim 75, wherein the pilot signal is transmitted to the computer system in response to determining that a difference between the source data and the semantically decoded data is greater than a threshold.

79. The apparatus of claim 75, the operations further comprising:
generating second semantically encoded data representing the semantically decoded data, wherein the first semantically encoded data is generated based on the first computer knowledge base;
comparing the first semantically encoded data and the second semantically encoded data;
selectively transmitting the pilot signal to the computer system based on the comparison between the first semantically encoded data and the second semantically encoded data.
wherein the pilot signal is transmitted to the computer system in response to determining that a difference between the first semantically encoded data and the second semantically encoded data is greater than a threshold.

80. The apparatus of claim 75, the operations further comprising:
generating syntactically encoded data representing the first semantically encoded data; and
transmitting the syntactically encoded data to the second computer system.

81. The apparatus of claim 80, wherein the syntactically encoded data is transmitted to the computer system via a wireless network.

82. The apparatus of claim 75, wherein the apparatus is a user equipment (UE) of a wireless network.

83. The apparatus of claim 75, wherein the apparatus is a base station of a wireless network.

84. One or more non-transitory computer readable media storing instructions that, when executed by one or more processors, cause the one or more processors to perform operations comprising:
obtaining, by a first computer system, source data for transmission to a second computer system;
generating, by the first computer system, first semantically encoded data representing the source data, wherein the first semantically encoded data is generated based on:
a first computer knowledge base stored locally by the first computer system, and
a second computer knowledge base shared between the first computer system and the second computer system;
decoding, by the first computer system, the first semantically encoded data based on the second computer knowledge base to generate semantically decoded data;
comparing, by the first computer system, the source data and the semantically decoded data; and
selectively transmitting, by the first computer system, a pilot signal to the second computer system based on the comparison between the source data and the semantically decoded data.
